(19) United States
(12) Patent Application Publication
(10) Pub. No.: US 2025/0215591 A1
(43) Pub. Date: Jul. 3, 2025

(54) ELECTROLYSIS SYSTEM AND OPERATION METHOD THEREOF

(71) Applicant: H2PRO LTD, Caesarea (IL)

(72) Inventors: Hen DOTAN, Richan (IL); Ofer SAMOCHA, Rishon Lezion (IL); Sunny MARUELI, Tel Aviv (IL); Mordechay MOSHKOVICH, Raanana (IL)

(21) Appl. No.: 18/850,493

(22) PCT Filed: Mar. 23, 2023
(86) PCT No.: PCT/IL2023/050309

§ 371 Date: Sep. 24, 2024

Related U.S. Application Data
(60) Provisional application No. 63/269,886, filed on Mar. 24, 2022.

(51) Int. Cl. C25B 15/02; C25B 1/04; C25B 9/65; C25B 9/70

(52) U.S. Cl. CPC C25B 15/02; C25B 1/04; C25B 9/65; C25B 9/70

(57) ABSTRACT

Electrolysis techniques and system implementations are disclosed comprising a plurality of reactors, each comprising electrolysis electrodes and configured to carry out a sequence of phases of an electrolysis process phase-shifted with respect to a sequence of phases of the electrolysis process carried out by at least another one of said plurality of reactors, one or more power sources for driving the electrolysis processes carried out by the plurality of reactors, and a control system configured to monitor changes in a power capacity of at least one of the one or more power sources and based thereon perform at least one of the following: (i) activate or deactivate one or more of the electrolysis processes carried out by the plurality of reactors, (ii) adjust a time duration of at least one of the phases of the electrolysis process; (iii) adjust the power supplied to at least one of the plurality of reactors from the one or more power sources; and/or (iv) adjust, remove or introduce, at least one phase of the electrolysis process.

### TECHNOLOGICAL FIELD

The present invention is generally in the field of electrolysis and particularly relates to electrolyzers' control schemes.

### BACKGROUND

This section intends to provide background information concerning the present application, which is not necessarily prior art.

Electrolyzers usually receive their power supply from the electric grid infrastructures, and they are typically designed to operate with a stable power supply in order to obtain optimal hydrogen production rates. A continuous and stable power supply is particularly needed in such systems because sudden drops in the electrolyzers' electric power supply may result in electrodes degradation and hydrogen production stops. As in electrolysis hydrogen and oxygen are simultaneously produced at the same time (hydrogen on the cathode, and oxygen on the anode), a membrane is typically placed between the two electrodes in order to prevent mixture of the produced gasses. However, some of the produced hydrogen and oxygen gasses will still diffuse through the membrane, recombining with the other gas to form water, thereby reducing the efficiency of the production process.

At low powers, this trickle of gases is more pronounced, with a higher share of hydrogen (and oxygen) crossing. It is noted in this connection that reductions in the electric power supply is inevitable when renewable power sources are used to generate the electric power supply for the electrolysis equipment. Since renewable power sources are unstable in nature, alternations in the electric power supply regularly occur in accordance with the changes in availability and/or intensity of its renewable source.

If this gas drip is increased above the flammability limit, this can result in combustion. In addition, although the power provided to the electrolyzers' electrodes can be reduced, other components of the Electrolyzer system, such as pumps, can't be operated at low-power level efficiently, resulting in lower-efficiency overall (balance of plant—BoP).

Using green energy sources for electrolysis systems is a challenging task since the power produced by most renewable energy sources has an intermittent nature, such that significant fluctuations in the available electric power occur normally. In particular, wind and solar based power sources, which are considered the largest renewable power sources, can change rapidly in intensity e.g., due to weather conditions. Connecting an electrolyzer system to such a renewable power source is therefore challenging. For example, solar power plants utilize serial/parallel connections of a plurality of photovoltaic (PV) cells to convert solar energy into electrical energy. The operation of such solar power plants is strongly influenced by the local climate conditions (e.g., temperature, wind, and availability of the solar radiation) and electrical parameters (e.g., PV cell temperature).

Electrochemically Thermally Activated Chemical cell (E-TAC) (e.g., as disclosed in International Patent Publication Nos. WO 2022/029776 and/or WO 2022/029777, of the same Applicant hereof, the disclosure of which is incorporated herein by reference) is a new type of hydrogen-production system, that separates hydrogen and oxygen production into different “phases”, and can achieve much higher efficiencies compared to conventional electrolysis systems. As hydrogen and oxygen are not produced at the same time in E-TAC systems, there is no need for a membrane to separate between the electrodes, and there is no danger of hydrogen and oxygen mixing at low power consumption conditions.

This means that E-TAC systems can inherently support low-power consumption conditions. However, the operation of an E-TAC system should be carefully controlled in order for it to operate efficiently under such low-power consumption conditions.

### GENERAL DESCRIPTION

In a broad aspect the present application provides plant management schemes for a plant having at least one power source, and/or a number of simultaneously operating processes, susceptible to changes and/or discontinuities at any time during its operation. For example, in some embodiments at least one power source of the plant is a renewable power source (e.g., solar radiation) which availability and/or power intensity may unpredictably change during the plant's operation. In some embodiments the plant is configured to simultaneously perform a number of production (e.g., electrolysis) processes, which may be rapidly changed during its operation to add, or reduce, such production processes according to production requirements/conditions and/or the availability of the at least one renewable power source and/or its power intensity.

In some embodiments the power management of the plant is configured to monitor power production levels of the at least one renewable power source and based thereon determine how to exploit the power thereby generated, and/or new operation state and/or conditions of the plant's processes. For example, if the at least one renewable power source can provide high power production levels, the power management system can draw therefrom sufficient power for operating the production processes of the plant, and supply the residuals of the generated power to the electric grid system. When the power production levels of the at least one renewable power source is reduced to a level smaller than the high-power level and greater than a define medium power production level, the power management system can direct all of the power thereby generated for the operation of the production processes of the plant.

If the power production level of the at least one renewable power source is reduced to a level smaller than the defined medium-power production level and greater than a define low-power production level, the power management system can direct all of the power thereby generated for the operation of the production processes of the plant and consume some amounts of electric grid power for operating the production processes of the plant, and/or change state and/or conditions of operation of the production processes to adjust their power consumption to the new power capacity level of the at least one renewable power source.

If the power production level of the at least one renewable power source is further reduced e.g., to a level smaller than the defined low-power production level, the power management system may reduce the number simultaneously operating production processes of the plant and/or draw more power from the electric grid. In case the power production level of the at least one renewable power source is reduced to a critically minimal level the power management system may consume greater power from the electric grid, or alternatively shutdown the production processes of the plant, and restart at least some of them when a sufficient power is generated by the at least one renewable power source.

Additionally, or alternatively, the power management system can be configured to adjust the operation state and conditions of the production processes of the plant responsive to changes in the power production levels of the renewable power source and their expected time durations. For example, if minor short-term fluctuations in the power produced by the at least one renewable power source are observed, the power management system may adjust the operation of the simultaneously operated production processes to reduce the total power consumption of the plant e.g. by changing operation mode of plant components into low power consumption. If longer-term changes in the power produced by the at least one renewable power source are observed, the power management system may change operation sequences of the production processes to further adjust the power consumption of the plant e.g. by reducing the time durations of power consuming phases, and/or increasing the time durations of substantially inactive phases i.e., phases in the production processes which require relatively small, or no, power consumption.

If longer term changes are observed in power production level of the at least one renewable power source the power management system may further adjust the operation of the production processes of the plant to further reduce its power consumption e.g., by reducing the number and/or time durations of power consuming phases, and/or increasing the number and/or time durations of substantially inactive steps, and/or deactivating one or more of the production processes.

In one aspect there is provided an electrolysis system comprising a plurality of reactors, each comprising electrolysis electrodes and configured to carry out a sequence of phases of an electrolysis process phase-shifted (i.e., having a phase difference) with respect to a sequence of phases of the electrolysis process carried out by at least another one of the plurality of reactors, one or more power sources for driving the electrolysis processes carried out by the plurality of reactors, and a control system configured to monitor changes in a power capacity of at least one of the one or more power sources and based thereon perform at least one of the following: (i)
activate or deactivate one or more of the electrolysis processes carried out by the plurality of reactors; (ii) adjust a time duration of at least one of the phases of the electrolysis process; (iii) adjust the power supplied to at least one of the plurality of reactors from the one or more power sources; and/or (iv) adjust, remove or introduce, at least one phase of the electrolysis process.

The system can be configured to carry out the electrolysis process in each reactor in continuously repeated cycles, each cycle comprising at least one Hydrogen production (H) phase from a cold electrolyte solution, followed by a cold electrolyte pushout phase (L-H) of replacing the cold electrolyte by a washing solution, followed by at least one washing phase (L) of washing the electrolysis electrodes of the reactor, followed by a washing solution pushout phase (O-L) of replacing the washing solution by a hot electrolyte solution, followed by at least one Oxygen production (O) phase from the hot electrolyte, followed by a hot electrolyte pushout phase (L-O) of replacing the hot electrolyte solution by a washing solution, followed by at least one washing phase (L) of washing the electrolysis electrodes of the reactor, followed by a washing solution pushout phase (H-L) of replacing the washing solution by a cold electrolyte solution.

The system can comprise at least one Hydrogen production arresting phase (H—) between the at least one Hydrogen production (H) phase from a cold electrolyte solution and the cold electrolyte pushout phase (L-H), and/or after the washing solution pushout phase (H-L) and before a new Hydrogen production (H) phase of a new cycle is commenced.

The system can configured to determine the time durations of one or more of the phases and/or of the entire electrolysis process based on at least one of the following: an electrolysis cycle time duration τ_{c} (or any derivative thereof); and/or number of reactors in the system Nₛ (or any derivative thereof); and/or number of active reactors in the system Nₐ (or any derivative thereof); and/or length/time duration of the Hydrogen production (H) phase τ_{c} (or any derivative thereof); and/or length/time duration of the (L-O) and (O-L) pushes τₕ (or any derivative thereof); and/or length/time duration of the (L-H) and (H-L) pushes τₗₕ (or any derivative thereof); and/or length/time duration of the Oxygen production (O) phase τₒ (or any derivative thereof); and/or average length/time duration of the leftover/wash (L) phase τₗ (or any derivative thereof); and/or average length/time duration of the (H—) phase τₕ₋ (or any derivative thereof).

The system can be configured to determine the time durations of one or more of the phases and/or of the entire electrolysis process based on the following: length/time duration of the (L-H) and (H-L) pushes τₗₕ (or any derivative thereof); length/time duration of the (L-O) and (O-L) pushes τₗₒ (or any derivative thereof); length/time duration of the Hydrogen production (H) phase τₕ (or any derivative thereof); number of reactors in the system Nₛ (or any derivative thereof); and/or number of active reactors in the system Nₐ (or any derivative thereof).

The system can be configured to determine the time durations of one or more of the phases and/or of the entire electrolysis process based on the following: length/time duration of the Hydrogen production (H) phase τₕ (or any derivative thereof); length/time duration of the Oxygen production (O) phase τₒ (or any derivative thereof); average length/time duration of the leftover/wash (L) phase τₗ (or any derivative thereof); length/time duration of the (L-H) and (H-L) pushes τₗₕ (or any derivative thereof).

Optionally, but in some embodiments preferably, a time duration of each of the Hydrogen production (H) phase, of the Hydrogen production arresting phase (H—), of the washing phase (L), and of the Oxygen production (O) phase, substantially equals to a multiplication of a step time duration by a natural number, the step time duration being a time duration of at least one of the pushout phases. The system can be configured such that the total time duration of the washing phases (L) in each cycle substantially equals to at least: a multiplication of the step time duration by four when the number of phase shifts between the reactors is one, two or three; and/or a multiplication of the step time duration by six when the number of phase shifts between the reactors is four; and/or a multiplication of the step time duration by ten when the number of phase shifts between the reactors is five; and/or the time duration of the total phase shift minus a time duration of two phases when the number of phase shifts between the reactors is greater than five.

The system can be configured such that the total time duration of the Hydrogen production arresting phase (H—) in each cycle substantially equals to at least: a multiplication of the step time duration by two when the number of phase shifts between the reactors is one; and/or a multiplication of the step time duration by five when the number of phase shifts between the reactors is two; and/or a multiplication of the step time duration by two when the number of phase shifts between the reactors is three; and/or a multiplication of the step time duration by three when the number of phase shifts between the reactors is four; and/or a multiplication of the step time duration by four when the number of phase shifts between the reactors is of five phases; and/or the time duration of the total phase shift between the reactors minus a time duration of one phase when the number of phase shifts between the reactors is greater than five.

The system can be configured such that the total time duration of the cycle substantially equals to at least: a multiplication of the step time duration by twelve and by the number of phase shifts between the reactors when the number of phase shifts between the reactors is one; and/or a multiplication of the step time duration by seven and by the number of phase shifts between the reactors when the number of phase shifts between the reactors is two; and/or a multiplication of the step time duration by five and by the number of phase shifts between the reactors when the number of phase shifts between the reactors is three; and/or a multiplication of the step time duration by four and by the number of phase shifts between the reactors when the number of phase shifts between the reactors is inclusively between four to eight; and/or a multiplication of the step time duration by three and by the number of phase shifts between the reactors when the number of phase shifts between the reactors is greater than eight.

The system can be configured such that the total time duration of the Oxygen production (O) phase(s) in each cycle is greater than: a multiplication of the step time duration by two and by the number of phase shifts between the reactors minus a time duration of one phase when the number of phase shifts between the reactors is one; and/or a multiplication of the step time duration by the number of phase shifts between the reactors minus a time duration of one phase when the number of phase shifts between the reactors is greater than one.

The system can be configured such that subtraction of a total number of the step time duration in the cold electrolyte pushout phase (L-H) from a division of a difference between the total number of the step time duration in the cycle and the total number of the step time duration in the Hydrogen production (H) phase by the number of phase shifts between the reactors substantially equals to at least: nine when the number of phase shifts between the reactors is one; and/or five when the number of phase shifts between the reactors is two; and/or three when the number of phase shifts between the reactors is three or four; and/or two when the number of phase shifts between the reactors is inclusively between five and eight; and/or one when the number of phase shifts between the reactors is greater than eight.

In some embodiments the control system is configured to carry out at least one of the following: supply electric power from the power sources to an electric power grid when high power capacity of the power sources are thereby determined, and to consume electric power from the electric power grid when it is determined that the power capacity of the power sources is smaller than a predetermined medium power capacity level; deactivate all of the electrolysis processes carried out by the plurality of reactors when it is thereby determined that the power capacity of the power sources is smaller than a predetermined minimum power capacity level; adjust electric current supplied to at least one of the plurality of reactors when it is thereby determined that a reduction in the power capacity of the power sources is likely to cause short-term fluctuations in the power supply; further adjust a time duration of at least one of the phases of the electrolysis process when it is thereby determined that reduction in the power capacity of the power sources is likely to cause longer-term fluctuations in the power supply; further adjust a time duration of at least one of the phases and/or a sequence of phases of the electrolysis process when it is thereby determined that reduction in the power capacity of the power sources is likely to substantially reduce efficiency of the electrolysis process.

In some embodiments at least one, or all, of the power sources are renewable power sources. The control system can be configured to receive and process sensory data/signals indicative of changes in environmental conditions, and predict based thereon a likelihood of changes in the power capacity of the renewable power sources. Optionally, but in some embodiments preferably, at least one, or all, of the power sources are solar power sources, and the control system is configured to receive and process weather forecast data and predict based thereon a likelihood of changes in the power capacity.

The system comprises in some embodiments a reservoir containing a the hot electrolyte solution, a reservoir containing a the cold electrolyte solution, a reservoir containing a the washing solution, and equipment for controllably streaming the solutions between the reservoirs and each one of the plurality of reactors. The control system can configured to stream solution to each one of the plurality of reactors from the reservoirs at each phase of the electrolysis process carried out therein.

The control system is configured in some embodiments to apply electric voltage over the electrolysis electrodes of each one of the plurality of reactors only when carrying out a Hydrogen production (H) phase of the electrolysis process, and to circulate the cold electrolyte solution between the cold electrolyte solution reservoir and the reactors carrying out the Hydrogen production (H) phase of the electrolysis process.

The control system can be configured to carry out at least one of the following; push the cold electrolyte solution back into the cold electrolyte solution reservoir in the cold electrolyte pushout phase (L-H), by streaming the washing solution from the washing solution reservoir thereinto; circulate the cold electrolyte solution between the cold electrolyte solution reservoir and the reactors in the Hydrogen production arresting phase (H—) without applying the electric voltage to their electrolysis electrodes; circulate the washing solution between the washing solution reservoir and the reactors in the washing phase (L) for washing gaseous products residues from the electrolysis electrodes of said reactors; push the washing solution from the reactors back into the washing solution reservoir in the washing solution pushout phase (O-L), by streaming the hot electrolyte solution from the hot electrolyte solution reservoir into the reactors; circulate the hot electrolyte solution between the hot electrolyte solution reservoir and each one of the plurality of reactors in the Oxygen production phase (O) of the electrolysis process; push the hot electrolyte solution back into the hot electrolyte solution reservoir in the hot electrolyte pushout phase (L-O), by streaming the washing solution from the washing solution reservoir thereinto; circulate the washing solution between the washing solution reservoir and the reactors that completed the Oxygen production phase for washing Oxygen residues from the electrolysis electrodes of the reactors; push the washing solution from the reactors back into the washing solution reservoir in the washing solution pushout phase (H-L), by streaming the cold electrolyte solution from the cold electrolyte solution reservoir into the reactors; circulate the cold electrolyte solution between the cold electrolyte solution reservoir and the reactors that completed the Oxygen production phase without applying the electric voltage to their electrolysis electrodes.

The system can be configured to maintain the washing solution in the washing solution reservoir at a temperature substantially smaller than a temperature of the hot electrolyte solution and substantially greater than a temperature of the cold electrolyte solution. The washing solution reservoir comprises in some embodiments one or more cold washing solution sub-reservoirs for cold washing solutions maintained at temperature(s) greater than a temperature of the cold electrolyte solution, and one or more hot washing solution sub-reservoirs for hot washing solutions maintained at temperature(s) smaller than a temperature of the hot electrolyte solution and greater than temperature(s) of the cold washing solutions. The control system can be configured to use the cold washing solutions from the one or more cold washing solution sub-reservoirs in the hot electrolyte pushout phase (L-O) and in the at least one washing phase (L) carried out thereafter, and to use the hot washing solutions from the one or more hot washing solution sub-reservoirs in the cold electrolyte pushout phase (L-H) and in the at least one washing phase (L) carried out thereafter.

The system comprises in some embodiments at least two of the cold washing solution sub-reservoirs, temperatures of the cold washing solutions maintained in the at least two cold washing solution sub-reservoirs are distributed between the temperature of the cold electrolyte solution and a mid temperature of the cold and hot electrolyte solutions, and at least two of the hot washing solution sub-reservoirs, temperatures of the hot washing solutions maintained in the at least two hot washing solution sub-reservoirs are distributed between the mid temperature and the temperature of the hot electrolyte solution. The control unit can be configured to gradually increase the temperature of the washing solution streamed form the hot washing solution sub-reservoirs to the reactors in the cold electrolyte pushout phase (L-H), and to gradually decrease the temperature of the washing solution streamed form the cold washing solution sub-reservoirs to the reactors in the hot electrolyte pushout phase (L-O).

Each phase of the electrolysis process can comprise one or more steps each of a fixed predetermined time interval. The control system can be configured to determine the number of steps in each phase of the electrolysis based on at least one of the power capacity of the power sources and the phase-shift between electrolysis processes carried out by at least two of the reactors.

In another aspect there is provided an electrolysis plant comprising two or more of the electrolysis systems disclosed hereinabove or hereinbelow utilizing a single hot electrolyte reservoir, a single cold electrolyte reservoir, and one or more washing solutions reservoir, and wherein the control system is configured to carry out a sequence of the (L-H), (L) and (O-L), phases in one of the two or more electrolysis systems while carrying out a sequence of the (L-O), (L) and (H-L), phases in at least another one of the two or more electrolysis systems.

In yet another aspect there is provided an electrolysis method comprising carrying out an electrolysis process having sequence of phases in a plurality of reactors, each of the reactors comprising electrolysis electrodes and carrying out the electrolysis process with phase-shift with respect to at least another one of the plurality of reactors, monitoring changes in power capacity of one or more power sources used for carrying out the electrolysis process by the plurality of reactors and based thereon performing at least one of the following: activating or deactivating one or more of the electrolysis processes carried out by the plurality of reactors; adjusting a time duration of at least one of the phases of the electrolysis process; adjusting power supplied to at least one of the plurality of reactors from the one or more power sources; and/or adjusting, removing or introducing, at least one phase of the electrolysis process.

The comprising in some embodiments carrying out the electrolysis process in the reactors in a continuously repeated cycles, each cycle comprising at least one Hydrogen production (H) phase from a cold electrolyte solution, optionally followed and/or preceded by at least one Hydrogen production arresting phase (H—), followed by a cold electrolyte pushout phase (L-H) of replacing the cold electrolyte by a washing solution, followed by at least one washing phase (L) of washing the electrolysis electrodes of the reactor, followed by a washing solution pushout phase (O-L) of replacing the washing solution by a hot electrolyte solution, followed by at least one Oxygen production (O) phase from the hot electrolyte, followed by a hot electrolyte pushout phase (L-O) of replacing the hot electrolyte solution by a washing solution, followed by at least one washing phase (L) of washing the electrolysis electrodes of said reactor, followed by a washing solution pushout phase (H-L) of replacing the washing solution by a cold electrolyte solution.

The method can comprise setting a time duration of each of the Hydrogen production (H) phase, of the Hydrogen production arresting phase (H—), of the washing phase (L), and of the Oxygen production (O) phase, to substantially equal to a multiplication of a step time duration by a natural number, said step time duration being a time duration of at least one of the pushout phases.

The method comprising in some embodiment setting a total time duration of the washing phases (L) in each cycle to substantially equal to at least: a multiplication of the step time duration by four when the number of phase shifts between the reactors is one, two or three; and/or a multiplication of the step time duration by six when the number of phase shifts between the reactors is four; and/or a multiplication of the step time duration by ten when the number of phase shifts between the reactors is five; and/or the time duration of the total phase shift minus a time duration of two phases when the number of phase shifts between the reactors is greater than five.

The method comprising in some embodiment setting the total time duration of the Hydrogen production arresting phase (H—) in each cycle to substantially equal to at least: a multiplication of the step time duration by two when the number of phase shifts between the reactors is one; and/or a multiplication of the step time duration by five when the number of phase shifts between the reactors is two; and/or a multiplication of the step time duration by two when the number of phase shifts between the reactors is three; and/or a multiplication of the step time duration by three when the number of phase shifts between the reactors is four; and/or a multiplication of the step time duration by four when the number of phase shifts between the reactors is of five phases; and/or the time duration of the total phase shift between the reactors minus a time duration of one phase when the number of phase shifts between the reactors is greater than five.

The method comprising in some embodiment setting the total time duration of the cycle to substantially equal to at least: a multiplication of the step time duration by twelve and by the number of phase shifts between the reactors when the number of phase shifts between the reactors is one; and/or a multiplication of the step time duration by seven and by the number of phase shifts between the reactors when the number of phase shifts between the reactors is two; and/or a multiplication of the step time duration by five and by the number of phase shifts between the reactors when the number of phase shifts between the reactors is three; and/or a multiplication of the step time duration by four and by the number of phase shifts between the reactors when the number of phase shifts between the reactors is inclusively between four to eight; and/or a multiplication of the step time duration by three and by the number of phase shifts between the reactors when the number of phase shifts between the reactors is greater than eight.

The method comprising in some embodiments setting the total time duration of the Oxygen production (O) phase(s) in each cycle to be substantially greater than: a multiplication of the step time duration by two and by the number of phase shifts between the reactors minus a time duration of one phase when the number of phase shifts between the reactors is one; and/or a multiplication of the step time duration by the number of phase shifts between the reactors minus a time duration of one phase when the number of phase shifts between the reactors is greater than one.

The method comprising in some embodiment setting a subtraction of a total number of the step time duration in the cold electrolyte pushout phase (L-H) from a division of a difference between the total number of the step time duration in the cycle and the total number of the step time duration in the Hydrogen production (H) phase by the number of phase shifts between the reactors to substantially equal to at least: nine when the number of phase shifts between the reactors is one; and/or five when the number of phase shifts between the reactors is two; and/or three when the number of phase shifts between the reactors is three or four; and/or two when the number of phase shifts between the reactors is inclusively between five and eight; and/or one when the number of phase shifts between the reactors is greater than eight.

The method can comprise at least one of the following; supplying electric power from the power sources to an electric power grid when high power capacity of the power sources are thereby determined, and consuming electric power from the electric power grid when it is determined that the power capacity of said power sources is smaller than a predetermined medium power capacity level; deactivating all of the electrolysis processes carried out by the plurality of reactors when it is determined that the power capacity of the power sources is smaller than a predetermined minimum power capacity level; adjusting electric current supplied to at least one of the plurality of reactors when it is determined that a reduction in the power capacity of the power sources is likely to cause short-term fluctuations in the power supply; further adjusting a time duration of at least one of the phases of the electrolysis process when it is determined that reduction in the power capacity of the power sources is likely to cause longer-term fluctuations in the power supply; further adjusting a time duration of at least one of the phases and/or a sequence of phases of the electrolysis process when it is determined that reduction in the power capacity of the power sources is likely to substantially reduce efficiency of the electrolysis process;

At least one, or all, of the power sources can be renewable power sources, and the methos can comprise receiving and processing sensory data/signals indicative of changes in environmental conditions, and predicting based thereon a likelihood of changes in the power capacity of the renewable power sources. In possible embodiments at least one, or all, of the power sources are solar power sources, and the method can comprise receiving and processing weather forecast data and predicting based thereon a likelihood of changes in the power capacity.

The method may comprise streaming solution to each one of the plurality of reactors from at least one of a reservoir containing the hot electrolyte solution, a reservoir containing the cold electrolyte solution, and a reservoir containing the washing solution, at each phase of the electrolysis process carried out therein.

The method comprising in some embodiment at least one of the following: applying electric voltage over the electrolysis electrodes of each one of the plurality of reactors only when carrying out a Hydrogen production (H) phase of the electrolysis process, and circulating the cold electrolyte solution between the cold electrolyte solution reservoir and the reactors carrying out the Hydrogen production (H) phase of the electrolysis process; pushing the cold electrolyte solution back into the cold electrolyte solution reservoir in the cold electrolyte pushout phase (L-H), by streaming the washing solution from the washing solution reservoir thereinto; circulating the cold electrolyte solution between the cold electrolyte solution reservoir and the reactors in the Hydrogen production arresting phase (H—), without applying the electric voltage to their electrolysis electrodes; circulating the washing solution between the washing solution reservoir and the reactors in the washing phase (L) for washing gaseous products residues from the electrolysis electrodes of said reactors; pushing the washing solution from the reactors back into the washing solution reservoir in the washing solution pushout phase (O-L), by streaming the hot electrolyte solution from the hot electrolyte solution reservoir into the reactors; circulating the hot electrolyte solution between the hot electrolyte solution reservoir and each one of the plurality of reactors in the Oxygen production phase (O) of the electrolysis process; pushing the hot electrolyte solution back into the hot electrolyte solution reservoir in the hot electrolyte pushout phase (L-O), by streaming the washing solution from the washing solution reservoir thereinto; pushing the washing solution from the reactors back into the washing solution reservoir in the washing solution pushout phase (H-L), by streaming the cold electrolyte solution from the cold electrolyte solution reservoir into said reactors; maintaining the washing solution in the washing solution reservoir at a temperature substantially smaller than a temperature of the hot electrolyte solution and substantially greater than a temperature of the cold electrolyte solution; maintaining cold washing solutions contained in one or more cold washing solution sub-reservoirs at temperature(s) greater than a temperature of the cold electrolyte solution, and maintaining hot washing solutions contained in one or more hot washing solution sub-reservoirs at temperature(s) smaller than a temperature of the hot electrolyte solution and greater than temperature(s) of the cold washing solutions, and using the cold washing solutions from the one or more cold washing solution sub-reservoirs in the hot electrolyte pushout phase (L-O) and in the at least one washing phase (L) carried out thereafter, and using the hot washing solutions from the one or more hot washing solution sub-reservoirs in the cold electrolyte pushout phase (L-H) and in the at least one washing phase (L) carried out thereafter; setting temperatures of cold washing solutions contained in at least two of the cold washing solution sub-reservoirs distributed between the temperature of the cold electrolyte solution and a mid temperature of the cold and hot electrolyte solutions, and setting temperatures of hot washing solutions contained in at least two of the hot washing solution sub-reservoirs distributed between the mid temperature and the temperature of the hot electrolyte solution; gradually increasing the temperature of the washing solution streamed form the hot washing solution sub-reservoirs to the reactors in the cold electrolyte pushout phase (L-H), and gradually decreasing the temperature of the washing solution streamed form the cold washing solution sub-reservoirs to the reactors in the hot electrolyte pushout phase (L-O); setting each phase of the electrolysis process to have one or more steps each of a fixed predetermined time interval, and determining the number of steps in each phase of the electrolysis based on at least one of the power capacity of the power sources and the phase-shift between electrolysis processes carried out by at least two of the reactors; carrying out a sequence of the (L-H), (L) and (O-L), phases in one electrolysis system while carrying out a sequence of the (L-O), (L) and (H-L), phases in at least another electrolysis system, the electrolysis systems utilizing a single hot electrolyte reservoir, a single cold electrolyte reservoir, and one or more washing solutions reservoir.

### BRIEF DESCRIPTION OF THE DRAWINGS

In order to understand the subject matter disclosed herein and to see how it may be carried out in practice, embodiments will now be described, by way of non-limiting example only, with reference to the accompanying drawings. Features shown in the drawings are meant to be illustrative of only some embodiments of the disclosed subject matter, unless otherwise implicitly indicated. In the drawings like reference numerals are used to indicate corresponding parts, and in which:

FIG. 1A to 1C schematically illustrating plant (e.g., electrolysis) power management schemes according to some possible embodiments, wherein FIG. 1A schematically illustrates a plant management system and FIGS. 1B and 1C are flowcharts of possible power management schemes;

FIG. 2A to FIG. 2J schematically illustrate an electrolysis cycle according to some possible embodiments;

FIGS. 3A to 3E depicts rules and assumptions to be fulfilled by electrolysis control schemes according to some possible embodiments;

FIGS. 4A to 4C depicts several conditions followed by electrolysis control schemes according to some possible embodiments; and

FIGS. 5A to 5C, and 6A to 6F, depicts control rules usable for electrolysis processes according to some possible embodiments;

FIGS. 7A and 7B exemplify an activation of a new Set during operation of the electrolysis system according to some possible embodiments;

FIGS. 8A to 8C exemplify an deactivation of a Set during operation of the electrolysis system according to other some possible embodiments;

FIG. 9 schematically illustrates a plant according to some possible embodiments; and

FIG. 10 demonstrates phases of an electrolysis process carried out in a plant as exemplified in FIG. 9.

### DETAILED DESCRIPTION OF EMBODIMENTS

One or more specific and/or alternative embodiments of the present disclosure will be described below with reference to the drawings, which are to be considered in all aspects as illustrative only and not restrictive in any manner. It shall be apparent to one skilled in the art that these embodiments may be practiced without such specific details. In an effort to provide a concise description of these embodiments, not all features or details of an actual implementation are described at length in the specification. Elements illustrated in the drawings are not necessarily to scale, or in correct proportional relationships, which are not critical. Emphasis instead being placed upon clearly illustrating the principles of the invention such that persons skilled in the art will be able to make and use the electrolysis techniques, once they understand the principles of the subject matter disclosed herein. This invention may be provided in other specific forms and embodiments without departing from the essential characteristics described herein.

Various “green” power sources behave differently in terms of their power profiles. For example, solar based power sources have a general fixed daily operation profile that changes between seasons, in addition to the fast power production changes that occur as a result of weather changes during the day e.g., due to clouds, which immediately affect availability and/or intensity of the produced electric power.

In E-TAC system, for example, if the available power supply could be predicted in advance, it could be used by the power management system and by the E-TAC control system for optimization. For solar energy sources, predicting available power could be both trivial (e.g., no power at night) or very complex (using real-time satellite images or sky photography to predict cloud cover in the next 5 minutes over the PV field/panels). As cloud cover can change in seconds, the output from a photovoltaic (PV) array power fluctuates just as fast.

Wind energy output also varies widely, but since the wind turbine has a large inertia the response to varying wind intensity is slower and accordingly the power management system can rely on the wind changes readings to determine the required response.

In addition to changes in the renewable power resource itself, the available power supply used for electrolysis e.g., for producing hydrogen, may depend on other factors as well. For example, if the feed-in price for electricity is high, it may be more economical to divert more of the power generated by the renewable power plant (e.g., PV array, wind farm, or suchlike) to the electric grid. On the other hand, if grid electricity prices drop low enough, it may be economical to draw additional power from the electric grid. Similar to power availability, these/other factors can change the power supplied to electrolysis systems e.g., for hydrogen production, at predictable (e.g., higher electricity prices in January) and less predictable (e.g., a gas power plant failure due to freezing pipes) ways (e.g., day/night time electricity prices).

The present application provides techniques for optimizing the operation of E-TAC electrolysis systems under intermittent power conditions. The techniques disclosed herein are based in some embodiments on various responses corresponding to the response time and the magnitude of the power changes. For example, solar power has a general fixed daily operation profile that changes between seasons, in addition to fast power changes that occur as a result of weather changes during the day e.g., due to clouds, which immediately affect the power production capabilities. Prediction of such conditions may relate on weather forecast and real time sky photography, such fast changes and related predictions require fast power regulation response from the power management system being used.

Embodiments disclosed herein provide techniques for coupling between renewable (e.g., solar) power sources and E-TAC electrolysis systems, enabling the required “look-ahead” forecast for continuous and/or efficient operation of E-TAC electrolysis systems, in order to mitigate for the intermittence of power supply from renewable power sources.

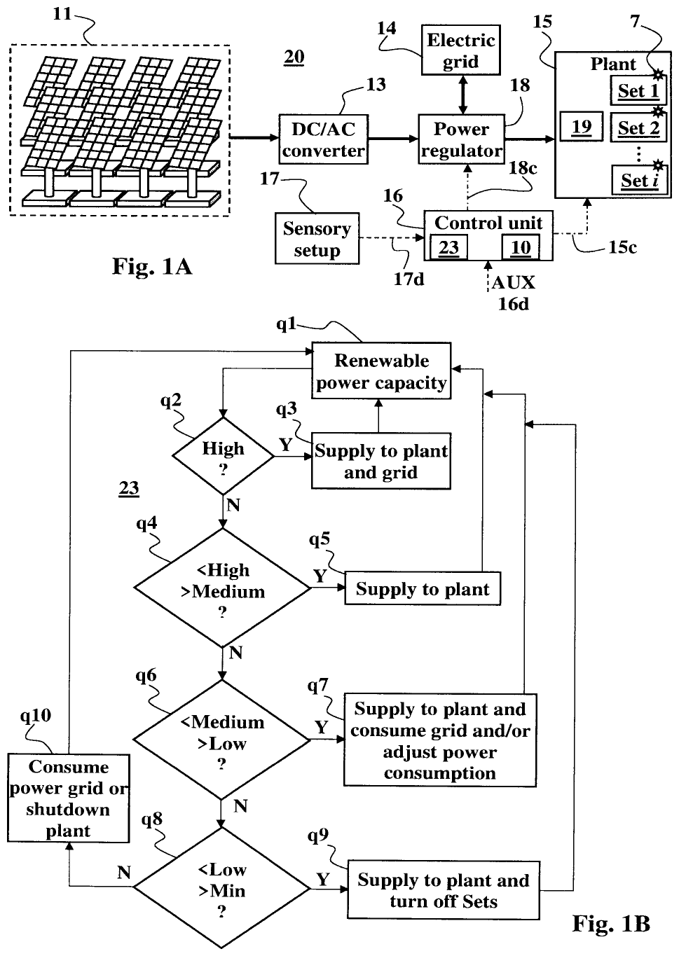

FIG. 1A schematically illustrates a plant system 20 configured to power a plant 15 (e.g., electrolysis system) from a renewable power source (e.g., solar power plant) 11 and/or the electric grid infrastructures 14. If the renewable power source 11 is a DC (direct current) power source, it may be converted into AC (alternating current) electric power by one or more DC to AC converters 13. One or more power regulators 18 can be used to regulate the use of the electric power generated by the renewable power source 11, and/or the sources of the electric power supplied to the plant 15 from a plurality or different sources, such as the renewable power source 11 and the electric grid 14.

The control system 16 is configured and operable to receive and process sensory data/signals 17d e.g., from one or more sensor devices 17, indicative of environmental conditions that can affect the electrical power capacity of the renewable power source 11 (e.g., radiation's intensity and/or angle of incident, ambient temperature, wind direction/velocity, etc). Additionally, or alternatively, the control system 16 may receive auxiliary data 16d pertaining to the renewable electrical power source 11 and/or the other electrical power sources e.g., general publicly available data, such as weather forecasts, satellite weather images, current electricity power price information, or policies (e.g., no power may be directed for E-TAC operation between 2 to 4 pm). For example, the auxiliary data 16d can be received from external sources, such as data/computer networks/the Internet, cellular networks, satellites, or suchlike. The control system 16 can be configured to forecast the projected electric power capacity of the renewable power source 11 in order to facilitate optimal operation of the plant/electrolysis system 15. Based on the received and processed sensory data 17d and/or auxiliary data 16d the control system 16 generates control data/signals 18c for regulating the use of electric power generated by the renewable power source 11, and/or control data/signals 15c for adjusting the operating state and/or conditions of the plant 15.

The plant 15 comprises in some embodiments a plurality of sub-systems/reactors, generally referred to herein as sets, Set 1, Set 2, . . . , Set i. The plant 15 can further have one or more electric power conversion units 19 e.g., AC to DC convertors and/or DC to DC convertors. The control system 16 can be configured to use one or more algorithms for the generation of the control data/signals 18c/15c e.g., based on power management control process 10 and 23 respectively shown in FIGS. 1B and 1C. The control system 16 may utilize one or more processors and memories (not shown) to process the various data inputs and generate the respective control data/signals 18c/15c. Optionally, the control system 16 is implemented as a state machine with multiple inputs, some internal to the system (e.g., state-of-charge of the Sets, instantaneous power levels supplied to each Set; etc.), and some external, such as “lookahead” data (production requirement and power availability for the next 10 minutes; etc.). The control system 16/state-machine can be configured to use the data to decide about the use of the electric power generated by the renewable power source 11, and/or on the best action for adjusting the operating state/conditions of the Sets of the plant 15, at every point of time.

FIG. 1B is a flowchart demonstrating a power management process 23 usable by the control system 16 according to some possible embodiments. Though in this specific and non-limiting example the power management process 23 relies only on the renewable power capacity (q1) of the renewable power source 11, in possible embodiments additional data and information can be used, as will be exemplified hereinbelow. If the renewable power source 11 is operating at a defined high-capacity level (q2) the control data/signals 18c from the control system 16 can instruct the power regulator 18 to supply a portion of the electric power from the renewable power source 11 to the plant 15 and to supply another portion thereof to the electric grid 14 (q3). If the renewable power source 11 is producing electric power at a capacity smaller than the defined high-capacity level and greater than a defined medium-capacity level (q4), the control data/signals 18c from the control system 16 can instruct the power regulator 18 to supply all of the electric power from the renewable power source 11 to the plant 15 (q5).

If the renewable power source 11 is operating at a capacity smaller than the defined medium capacity level and greater than a defined low capacity level (q6), then the control data/signals 18c from the control system 16 can instruct the power regulator 18 to supply all of the electric power from the renewable power source 11 to the plant 15 and optionally consume electric power from electric grid 14 for operating the plant 15, and/or the control signals/data 15c from the control system 16 can be used to instruct the plant 15 to adjust the power consumption of its Sets to comply with the power supply limitations (q7). If the renewable power source 11 is operating at a capacity smaller than the defined low-capacity level and greater than a defined minimal-capacity level (q8), then the control data/signals 18c from the control system 16 can be used to instruct the power regulator 18 to supply all of the electric power from the renewable power source 11 to the plant 15 and optionally consume electric power from the electric grid 14 for operating the plant 15, and the control signals/data 15c from the control system 16 can be used to instruct the plant 15 to turn off one or more of its Sets (and/or sub-systems Subi) to comply with the new power supply limitations (q9). In case the electric power capacity of the renewable power source 11 is smaller than the defined minimal-capacity level, then the control data/signals 18c from the control system 16 can be used to instruct the power regulator 18 to consume all electric power required for the operation of the plant 15 from the electric grid 14, or alternatively, the control data/signals 15c from the control system 16 can be used to instruct the plant 15 to shutdown all/substantial operation of the plant 15 (q10).

Assuming 100% power represents the optimal working point for the plant 15 e.g., E-TAC system, the control system 16 can be configured to utilize several strategies to deal with changes in the electric power supply from the renewable power source 11, depending on the level of change and the time given for the system to adjust (which, in the worst case, can be immediate) as well as the rate of the change (e.g., 20% drop in 2 minutes is different from the same drop over 20 minutes).

FIG. 1C shows a flowchart of a plant (e.g., electrolysis) management process 10 according to some possible embodiments. The process 10 may start in a steady operation state (s1) in which the plant is operated with full power supply in its optimal production rate. The plant 15 may be restarted and/or start-up one or more of its Sets (and/or sub-systems Subi), if not in operation, or if were previously shutdown (e.g., in step q10 of process 23 and/or step s9 of process 10). Whenever a power supply change is encountered (s2, e.g., change in electric current/voltage) one or more conditions are checked (s3, s5, s7, . . . ) to determine optimal adjustments in the operation of the plant 15. For minor short-term fluctuations (<T₁, e.g., less than 5% of the time required to complete an electrolysis cycle, or less than the time required for 3 (three) steps of the electrolysis cycle) in the power supply (s3), and/or power supply changes that are smaller than a first predefined threshold value THR₁ (e.g., <20%) the system may change the applied electric current/voltage (s4) in the active electrolysis reactors Sets (and/or sub-systems Subi) accordingly.

Longer-term changes (<T₂, e.g., less than 15% of the time required to complete an electrolysis cycle, or less than the time required for 10 steps of the electrolysis cycle), and/or greater power supply magnitude changes (s5) e.g., power supply changes that are smaller than a second predefined threshold value THR₂ (e.g., <40%) may require in addition to changing the electric current supplied to the Sets also altering/reducing the step time duration of the electrolysis process (s6, in order to accommodate for the changes in the electric charge derived from the current change).

Larger changes in the time duration and/or power supply magnitudes (s7, <T₃, e.g., less than 30% of the time required to complete an electrolysis cycle, or less than the time required for 20 steps of the electrolysis cycle) and/or power supply magnitude changes that are smaller than a third predefined threshold value THR₃ (e.g., less than 60% causing reduced efficiency due to equipment, such as pumps, operating in long cycles/time intervals at low electric currents, which may entail malfunctions and/or damage to system components/equipment), may be mitigated by making further changes (s8) in the system operational sequence, by alterations in the number of steps per cycle, and/or the number of simultaneous active Sets (and/or sub-systems Subi) in the plant 15, as required according to the power capacity level of the renewable power source 11.

For very large changes in the electric power supply from the renewable power source 11 and/or in the time duration of the changes, the system may shut off one or more of its Sets (and/or sub-subsystems Subi,s9), and later restart them back on, thus adjusting the Sets ((and/or sub-subsystems Subi) participating in the production to the available power capacity of the renewable power source 11.

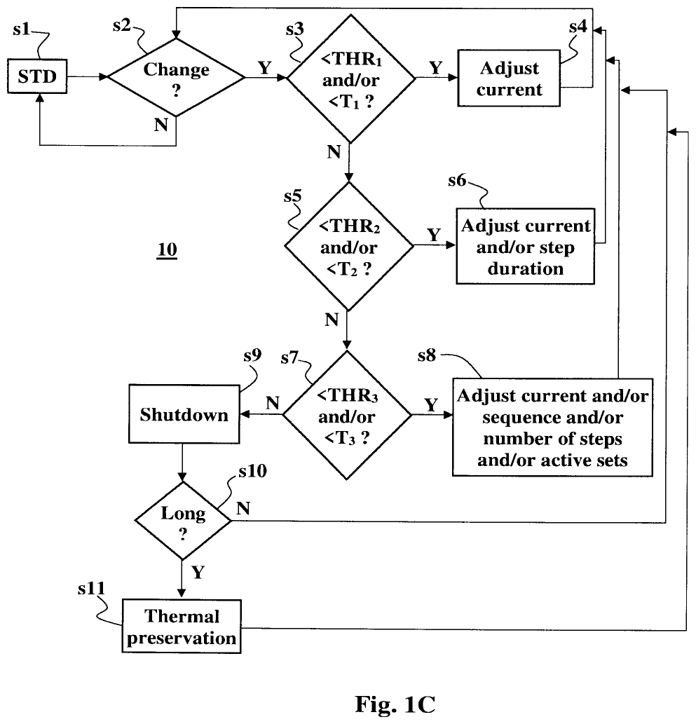

Long term (s10, several hours, e.g., solar power termination at night) may also require special attention (s11) in order to preserve the heat in the tanks, which may be handled by usage of electric grid power 14 for compensation of heat losses. Another option is to make use of the tanks insulation to preserve most of the heat and to use the exothermic nature of the TAC stage. In order to take advantage of the exothermic oxygen generation reaction, when the system is going to standby/off state one or more of the Sets (and/or sub-systems Subi) would stop after the washing step (the L phase shown in FIG. 2D), and before the TAC (exothermal) stage starts (FIG. 2E). This will provide that after the power supply to the plant 15 is restored, the electrodes will release heat during the TAC stage (phase O shown in FIG. 2F). For example, when restarting the plant systems 15 the Sets that were shutdown will go into the TAC stage (phase O shown in FIG. 2F) and the resulting heat will be released into the Hot tank, and thereby used for compensation over the minor heat losses during this stop (e.g., a few hours over night).

In some embodiments the process 10 is adapted to adjust the plant's power consumption and/or operating states/conditions of its Sets in accordance with the following table:

| Level | Current range | Action |
|---|---|---|
| STD (s1) | High production | No effect on E-TAC - negligibly |
| | (e.g., 80%-120%) | small change in supplied voltage |
| Level 1 (s3-s4) | Medium (e.g., | Longer step time of up to double |
| | 40%-80%) | of the original step time/size |
| Level 2 (s5-s6) | Low (e.g., | Add more steps up to a double the |
| | 40%-20%) | original number of steps |
| Level 3 (s7-s8) | Minimal (e.g., | Shutoff Sets (and/or sub-systems |
| | 0-20%) | Subi) |

The following description provides techniques of possible embodiments for controlling E-TAC sequences of an electrolysis plant 15, in order to compensate for electric power supply changes of the renewable power source 11. In general, for a given number of Sets, each comprising one or more electrolysis reactors, there are several specific possibilities for E-TAC sequences at optimal stabilized operation. These possibilities may have different number of steps in a complete operational cycle and/or different number of simultaneously H₂ producing Sets. An optimized sequence enables optimized power and energy distribution to the Sets. It is noted in this respect that an optimized sequence according to possible embodiments is configured to keep the system in a “steady state” i.e., hydrogen is produced at a steady rate and various components of the system, such as pumps, operate at a constant rate, etc.

In E-TAC, hydrogen (H₂) and oxygen (O₂) are produced at different phases. Electricity (power) is drawn for the electrolysis per se only in the hydrogen production phase (H, in FIGS. 2A to 2J). A single “reactor”/Set, wherein the E-TAC reactions take place, would therefore swing between phases of the electrolysis process/cycle. Similarly, different electrolytes (e.g., cold, hot, warm) need to be “pushed” in and/or out of the reactor/Set at different points of time within the electrolysis process/cycle. In a multi-Set system (e.g., where multiple reactors electrically connected in series and hydraulically connected in parallel), the electric power and the in/out flows to/from the reactors/Set can be balanced, such that the system as a whole is kept at a steady state.

An electrolysis plant 15 in embodiments hereof can thus include one or more hot tanks for storing and supplying a hot electrolyte solution at temperatures generally greater than 60° C., or greater than 90° C., but optionally can be in the range of room temperature (e.g., 23° C. to 30° C.) and up to 200° C., for hydrogen (H₂) gas production by one or more of its Sets/reactors. Optionally, the temperature of the hot electrolyte solution is in the range of 20° C. to 200° C., but In possible embodiments about 80° C. to 150° C.

The electrolysis plant 15 can also include one or more cold tanks for storing and supplying a cold electrolyte solution at temperatures generally less than 45° C. (but greater than a freezing temperature thereof), optionally about 30° C., for Oxygen (O₂) gas production by one or more of its Sets/reactors. The electrolysis plant 15 can as.Iso include one or more wash tanks (also referred to herein as leftovers) for storing and supplying a warm electrolyte solution at one or more intermediate temperatures generally in a range between the temperatures of the hot and cold electrolyte solutions, for washing its Sets/reactors in one or more intermediary steps between the gas production stages/phases of the electrolysis process.

Optionally, a different solution can be used for the hot electrolyte solution, the cold electrolyte solution and/or the warm/wash solution in the different stages of the electrolysis process. However, since the liquids in the different tanks/reservoirs are mixed over time (e.g., they come into contact in the “push” phases), they will eventually have the same chemical composition, but at different temperatures. Thus, in possible embodiments, the same electrolyte solution is used for the hot and cold electrolyte solutions, and the warm/wash solution.

Optionally, but in some embodiments preferably, the electrolyte solution is an aqueous-based solution comprising water and optionally at least one water-soluble solvent such as alcoholic materials (e.g., ethanol). The electrolyte solution may be as known in the art, but should generally be of basic pH (e.g., pH>7), though alkaline/basic electrolytes are also likely to work (e.g., NaOH). Optionally, but in some embodiments preferably, high concentration (5M) KOH is utilized for the the hot and cold electrolyte solutions, and the warm/wash solution.

To simplify operation, the plant system 15 adopts in some embodiments a uniform timing/“clock” convention i.e., it is operated in steps, each having a fixed length/time duration. The length of a step is determined in some embodiments by the shortest “operation” i.e., of “pushing” the electrolyte (in the reactor) from the previous step (to the appropriate piping) by the electrolyte of the next step. In some embodiments, the control system 16 can change the length/time duration of a step within some allowable margins, which allows some flexibility (e.g., it allows some change in the electric power supplied to the system).

With reference to FIGS. 2A to 2J, in some embodiments each Set of the plant 15 can be changed into operational phases of the following sequence:
Phase H illustrated in FIG. 2A: in this phase (H) hydrogen (H₂) is obtained from the cathode C, which is electrically charged by the power source (e.g., electric power converter 19 of the plant 15) i.e., electric power is supplied to the electrodes (i.e., to the anode—A and the cathode—C) while cold electrolyte (e.g., <40° C.) is cycled through the Set/reactors and the Cold tank;
Phase H—illustrated in FIG. 2B: in this phase (also referred to herein as Hydrogen production arresting phase) the electric power (12) supply is (off) disconnected from the electrodes A and C, and the cold electrolyte continues to cycle through the Set/reactors and the Cold tank. This phase is required to remove hydrogen residues left in the reactors/Set;
Phase L-H illustrated in FIG. 2C: in this phase the cold electrolyte is pushed out of the Set/reactors into the Cold tank, and at the same time, warm electrolyte (e.g., <80° C. and >40° C.) from the Leftover tank is simultaneously pushed into the Set/reactors;
Phase L illustrated in FIG. 2D: in this phase electrolyte cycles through the Set/reactors and the Leftover tanks to wash/remove any residual gas bubbles e.g., H₂ from the Set/reactors;
Phase O-L illustrated in FIG. 2E: in this phase electrolyte from the Set/reactors is pushed into the Leftover tank, and at the same time hot electrolyte (e.g., >90° C.) from the Hot tank is pushed into the Set/reactors;
Phase O illustrated in FIG. 2F: in this phase oxygen (O₂) is obtained from the anode A during it's chemical discharge process while circulating hot electrolyte through the Set/reactors;
Phase L-O illustrated in FIG. 2G: in this phase electrolyte is pushed from the Set/reactors into the Hot tank by warm electrolyte from the Leftovers tank;
Phase L illustrated in FIG. 2H: in this phase electrolyte again cycles through the Set/reactors and the Leftovers tank in order to wash/remove any residual gas bubbles e.g., O₂ from the reactors;
Phase H-L illustrated in FIG. 2I: in this phase electrolyte from the Set/reactors is pushed to the Leftovers tank as it is replaced with the cold electrolyte from the Cold tank;
Phase H—illustrated in FIG. 2J: in this phase cold electrolyte starts circulating between the Set/reactors and the Cold tank;
Phase H illustrated in FIG. 2A: the electric power supply (12) is turned on and a new electrolysis cycle starts.

In some embodiments a two or more consecutive L step phases can be conducted in a sequence. In addition, in possible embodiments the system may include two or more Leftover tanks (e.g., one or more hot leftover tanks and one or more cold leftover tanks). In possible embodiments, the power source 12 is configured to supply to the ‘A’ and ‘C’ electrodes an electric voltage generally greater 1.5 Volt, but higher voltage levels can similarly used. For example, in embodiments utilizing a plurality of electrolysis cells in each Set the voltage of the power source 12 can be few hundreds of Volts (e.g., 800 Volt). The electric current between the ‘A’ and ‘C’ electrode during the H (hydrogen production) phase (exemplified in FIG. 2A) generally depends on the dependent on the size of the electrolysis cell(s) used. In possible embodiments the current density can be in the range of 50-200 mA/cm². The ‘A’ and ‘C’ electrodes can be fabricated from an electrically conducting material.

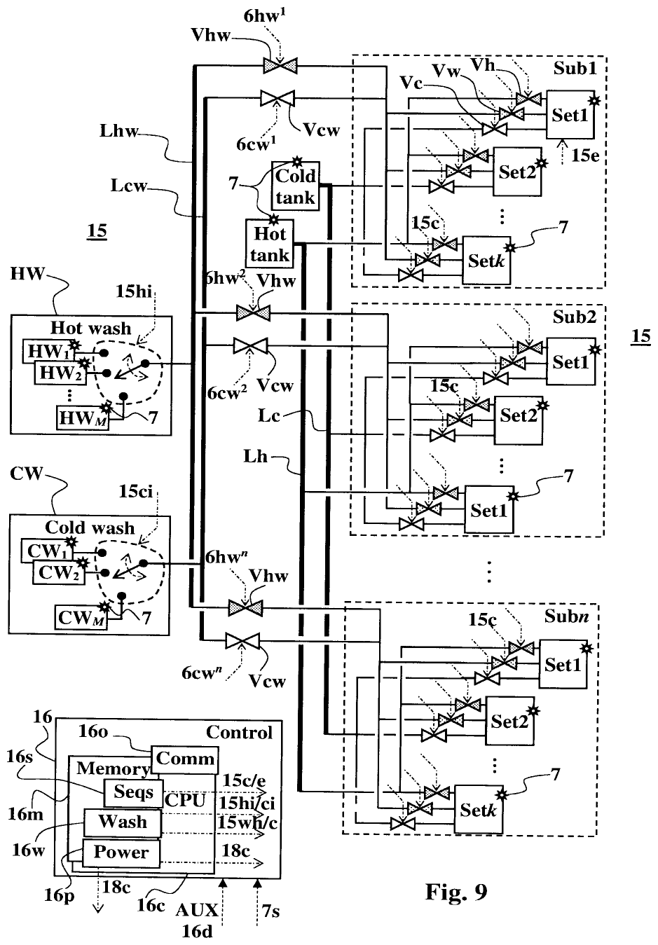

FIG. 9 schematically illustrates a plant system 15 according to some possible embodiments. In this specific and non-limitiung example the plant system 15 comprises a plurality of sub-system, Sub1, Sub2, . . . , Subn (n>0 is an integer number). As exemplified, each sub-system Subi (0<i≤n is an integer number) comprises a plurality of Sets/reactors, Set1, Set2, . . . , Setk (k>1 is an integer number), each Sets/reactors Setj (1<j≤k is an integer number) configured and operable to carry out an electrolysis process such as disclosed herein.

The plant 15 can thus comprise the Hot tank used for holding the hot electrolyte solution and supplying the same to the sub-systems Subi via a hot electrolyte line Lh, the Cold tank used for holding the cold electrolyte solution and supplying the same to the sub-systems Subi via a cold electrolyte line Lc, and one or more wash tanks HW/CW for holding a washing solution and supplying the same to the sub-systems Subi via a wash line Lw. Each Set/reactor Setj can be thus fluidly communicated with the hot electrolyte line Lh by a controlled hot valve Vh, to the cold electrolyte line Lc by a controlled cold valve Vc, and to the wash line Lw by a controlled wash valve Vw. Accordingly, each Set/reactor Setj can receive respective electric power control 15e data/signals for switching its electric connection of electric power source (12 in FIG. 1A) to its electrodes, and/or respective Seq control management control signals 15c for managing the states of its hot valve Vh, cold valve Vc, and wash valve Vw.

In possible embodiments, the Sets/reactors Setj of each sub-system Subi are operated to carry out the electrolysis process disclosed herein such that each Set/reactor Setj of a sub-system Subiis at a different phase of the electrolysis process exemplified if FIGS. 2A to 2J. Optionally, but in some embodiments preferably, the Sets/reactors Setj of each sub-system Subi are carrying out the electrolysis process exemplified in FIGS. 2A to 2J with a predefined phase shift therebetween. The return lines, pumps, ductwork, and other components, used to circulate the hot, cold and wash, solutions through the Sets/reactors Setj are not shown in FIG. 9 for the sake of simplicity, but they can be easily determined and implemented by an average practitioner based on the disclosure of the present application.

The plant system 15 comprises one or more Hot wash tanks HW for maintaining a hot wash solution, and one or more Cold wash tank(s) CW for maintaining a cold wash solution. Optionally, but in some embodiments preferably, the temperatures of the washing solutions stored in the hot and cold wash tanks, HW and CW, are substantially evenly distributed between the temperature of the hot electrolyte solution stored in the Hot tank and the temperature of the cold electrolyte solution stored in the Cold tank. This way, the system 15 can gradually change the temperature of the Sets/reactors Setj between the temperature of the cold and hot electrolyte solutions, by gradually increasing, or decreasing the temperature of the washing solution used to wash the electrolysis electrodes between the Oxygen and Hydrogen production phases of the electrolysis process.

The plant system 15 thus further comprises a hot wash line Lhw connected to the Hot wash tank(s) HW for supplying the hot wash solution to the sub-systems Subi via a respective controllable valve Vhw, and a cold wash line Low connected to the Cold wash tank(s) CW for supplying the cold wash solution to the sub-systems Subi via a respective controllable valve Vcw. The control system 16 is accordingly configured to generate either the 6hwⁱ or 6cwⁱ signal for connecting each sub-system Subi (i=1, 2, 3, . . . ) either to the Hot wash tank(s) HW or to the Cold wash tank(s) CW, in accordance with the electrolysis process phases carried therein. In some embodiments the control system is configured to generate control signals 6hwⁱ and 6cwⁱ such that whenever one of the sub-system Subx is connected to the hot wash line Lhw (to the HW tanks) at least another one of the sub-systems Suby (where x≠y, x,yϵ1, 2, 3, . . . ) is connected to the cold wash line Lcw (to the CW tanks).

In some embodiments the plant 15 comprises a plurality of hot wash tanks HW₁, HW₂, . . . , HW_{M} (M>0 is an integer number), collectively referred to herein as hot wash tanks HW, fluidly communicated with the hot wash solution line Lhw. The hot wash tanks HW can accordingly use ductwork and controlled valves (not shown) for allowing selection of at least one of the hot wash tanks HW from which to supply the hot washing solution to the hot solution line Lhw, utilizing control signals 15hi generated by the control system 16. In some embodiments the plant 15 comprises a plurality of cold wash tanks CW₁, CW₂, . . . , CW_{M}, collectively referred to herein as cold wash tanks CW, fluidly communicated with the cold solution line Lcw. The cold wash tanks CW can accordingly use ductwork and controlled valves (not shown) for allowing selection of at least one of the cold wash tanks CW from which to supply the cold washing solution to the cold solution line Lhw, utilizing control signals 15ci generated by the control system 16.

The temperatures of the washing solutions maintained in the plurality of hot wash tanks HW and cold wash tanks CW can be distributed between the temperatures of the cold electrolyte solution of the Cold tank and of the hot electrolyte solution of the Hot tank. For example, in embodiments utilizing a single washing solution tank the temperature of washing solution can be maintained around the average of the temperatures (Tₕ+T_{c})/2 of the hot (Tₕ) and cold (T_{c}) electrolyte solutions of the Hot tank and of the Cold tank, respectively. In embodiments utilizing two washing (i.e., hot and cold) tanks, the system is configured to (e.g., evenly) split the range of temperatures between the hot and cold electrolyte solutions into three (T_{c}↔T_{ch}), (T_{ch}↔T_{hc}) and (T_{hc}↔Tₕ), for maintaining the cold wash solution of the Cold wash tank CW around T_{ch} and the hot wash solution of the Hot wash tank HW around T_{hc}.

Similarly, if the plant system 15 comprises two Cold wash tanks CW and two Hot wash tanks HW, the system is configured to (e.g., evenly) split the range of temperatures between the hot and cold electrolyte solutions into five (T_{c}↔T_{c+}), (T_{c+}↔T_{ch}), (T_{ch}↔T_{hc}), (T_{hc}↔Tₕ₋) and (Tₕ₋↔Tₕ), for maintaining the washing solutions in the two cold wash tanks CW₁ and CW₂ at about T_{c+} and T_{ch} respectively, and for maintaining the washing solutions in the two hot wash tanks HW₁ and HW₂ at about T_{hc} and Tₕ₋ respectively. The states of various controlled valves depicted in the figures, and other components of systems, can be controlled by wired/lined (e.g., serial or parallel electrical data/signals, pneumatical or optical, bus, or suchlike), and/or wirelessly (e.g., using radio frequency communication, such as Bluetooth, WiFi, Zigbee, or suchlike), control signals (e.g., 15c, 6hwⁱ and/or 6cwⁱ) generated by the control system 16.

The control system 16 of plant 15 generally comprises one or more processors 16c and memories 16m configured and operable to store program code and/or other data required for running plant-management procedures and generating control data/signals required for operating the plant 15 e.g., the Sets' valves control 15c and electric power control 15e (collectively referred to herein as 15c/e) data/signals, the hot 15hi and/or cold 15ci sub-tanks selection (collectively referred to herein as 15hi/ci) data/signals, the hot 15wh and/or cold 15wc sub-tanks selection (collectively referred to herein as 15wh/c) data/signals, the power management/regulation data/signals 18c, and/or other indications/alerts and/or information relevant to the operation and states of the electrolysis processes thereby carried out.

In some embodiments the control system 16 comprises a Power management module 16p configured and operable to perform various power management procedures, such as, but not limited to, the power management process 23 demonstrated in the flowchart of FIG. 1B. In this specific and non-limiting example the Power management module 16p is configured and operable to generate the power management/regulation data/signals 18c for the power regulator(s) 18 (shown in FIG. 1A) of the plant 15.

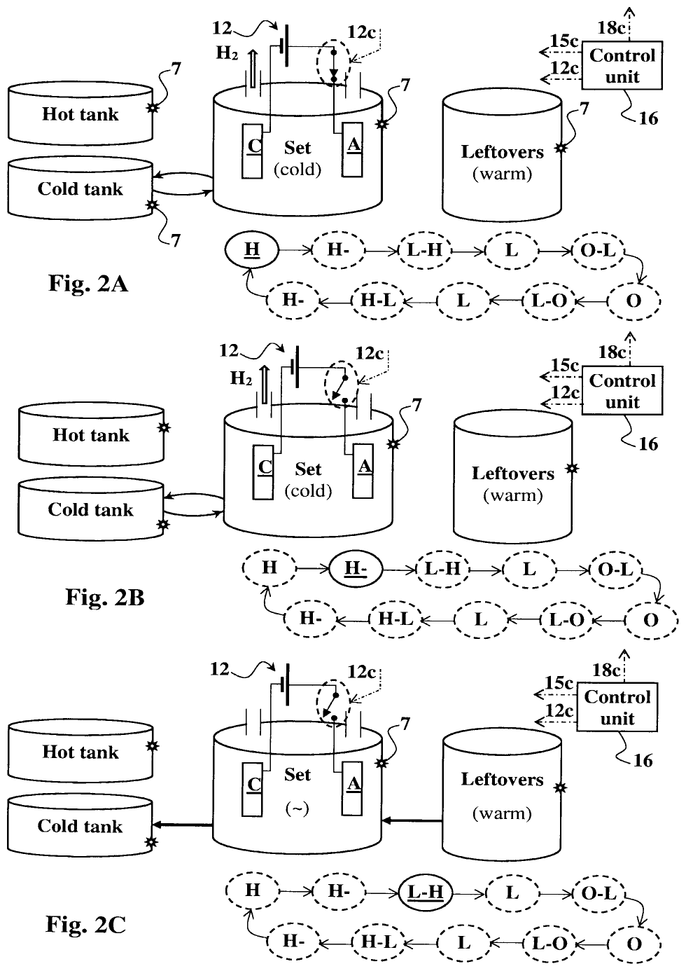

The control system 16 comprises in some embodiments a sequence (Seqs) management module 16s configured and operable to perform plant management procedures, such as, but not limited to, the plant management process 10 demonstrated in the flowchart of FIG. 1C. In this specific and non-limiting example the Seqs management module 16s is configured and operable to generate the valves control 15c data/signals and/or the electric power control 15e. In possible embodiments the Seqs management module 16s is configured and operable to determine step time duration for the phases of the electrolysis process, and/or phase shifts between the Sets/reactors Setj of each sub-system Subi, and/or the number steps of each phase, based at least partially on the conditions and/or rules and/or requirements defined in FIGS. 3A to 3E, and/or 4A to 4C, and/or 5A to 5C, and/or 6A to 6H, and/or 10.

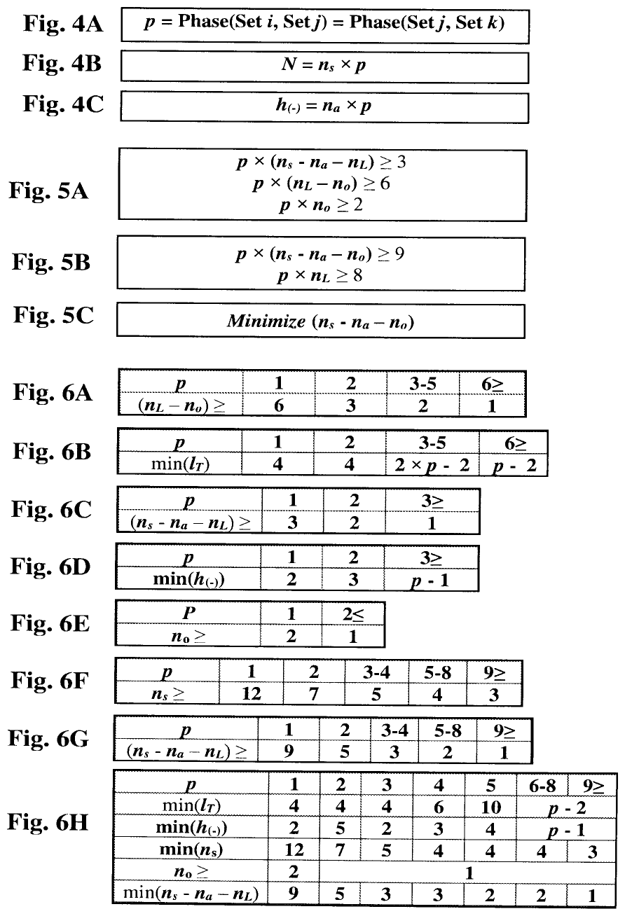

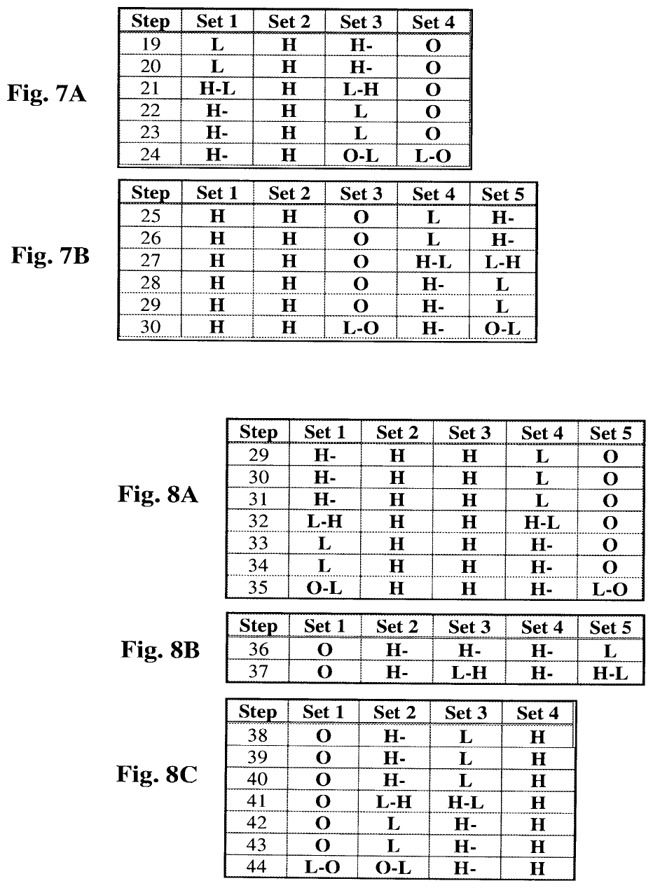

Optionally, but in some embodiments preferably, the Seqs management module 16s is also configured and operable to determine the number of active and/or inactive Sets/reactors Setj in each sub-system Subi during the operation o the plant 15 e.g., based on control data/signals 18c from the Power management module 16p. Accordingly, the Seqs management module 16s can be also configured and operable to generate control signals (not shown) for managing timing and/or phase of activation of Sets/reactors Setj during the operation o the plant 15 e.g., as exemplified in FIGS. 7A and 7B, and/or for managing timing and/or phase of inactivation of Sets/reactors Setj during the operation o the plant 15 e.g., as exemplified in FIGS. 8A to 8C.

The control system 16 can also comprise a Wash management module 16w configured and operable to perform various procedures for managing selection of either the Hot wash tanks HW or the Cold wash tanks CW for supplying washing solution to the wash line Lw of the plant 15. The Wash management module 16w can be further configured and operable to perform various procedures for managing selection of at least one of the hot wash tanks HW₁, HW₂, . . . , HW_{M}, used for supplying the hot washing solution to the wash line Lw of the plant 15, and/or for managing selection of at least one of the cold wash tanks CW₁, CW₂, . . . , CW_{M}, used for supplying the cold washing solution to the wash line Lw of the plant 15.

Optionally, but in some embodoments preferably, the plant 15 comprises various sensor devices 7 installed in its Sets/reactors Setj and/or solution tanks. The sensor devices 7 can be used to measure various parameters/conditions, such as solution temperature, pH, pressure conditions, flow rate, electrical conductivity, and electrical voltage and/or current of the electrodes. The control system 16 can be accordingly configured and operable to receive measurement data/signals 7s generated by the various sensor devices 7 and generate based thereon various control data/signal for operating the plant 15.

For example, in some embodiments the Wash management module 16w can be configured and operable to generate the control data/signals 15hi used for the selection of the at least one hot wash tanks HW₁, HW₂, . . . , HW_{M}, used for supplying the hot washing solution to the wash line Lw based on data/signals 7s indicative of the temperature of the electrolyte solution in the hot wash tanks HW₁, HW₂, . . . , HW_{M}.

Similarly, the Wash management module 16w can be configured and operable to generate the control data/signals 15ci used for the selection of the at least one cold wash tanks CW₁, CW₂, . . . , CW_{M}, used for supplying the cold washing solution to the wash line Lw of the plant 15 based on data/signals 7s indicative of the temperature of the electrolyte solution in the cold wash tanks CW₁, CW₂, . . . , CW_{M}.

This way, the control system can be adapted to carry out efficiently control and regulate the temperature of the hot and/or cold washing solutions by supplying the washing solutions from the tanks that had reached the required working temperature, while letting the other washing solution tanks to adjust the temperature of the washing solutions thereby stored to their required working temperatures.

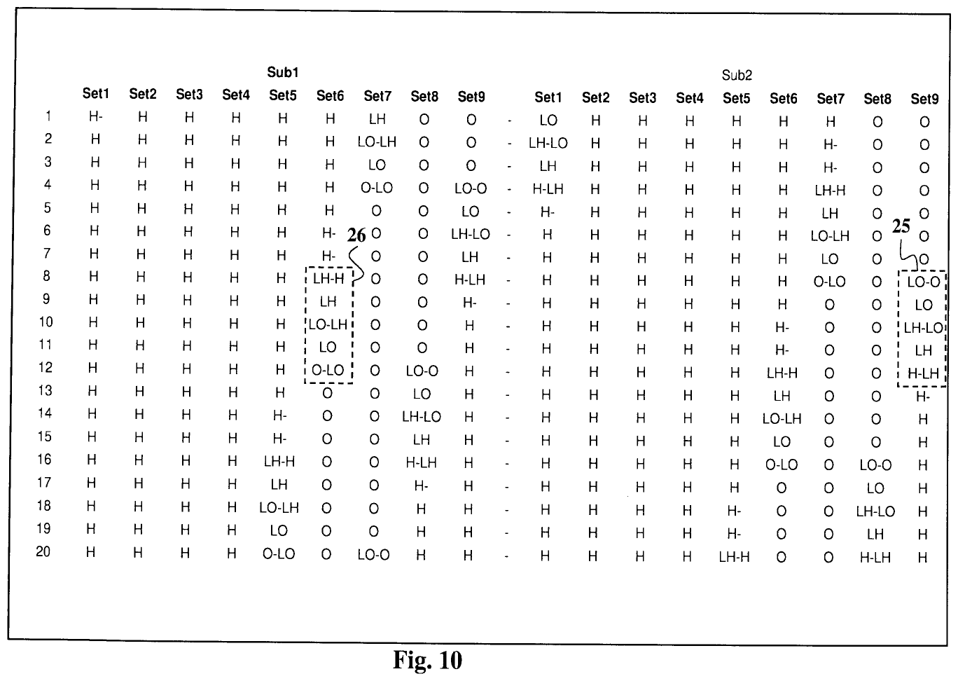

The plant 15 of some possible embodiments includes two sub-systems Sub1 and Sub2, or a plurality of Sub1 and Sub2 sub-system pairs. FIG. 10 demonstrates 20 phases of a plant 15 comprising in a possible embodiments two (2) sub-systems Sub1 and Sub2, each comprising nine (9) Sets/reactors Setj (1≤j≤9). FIG. 10 further demonstrates carrying hot and cold solution washing sequences of the Sets/reactors according to possible embodiments, using the washing solutions contained in the hot wash tanks HW and/or the cold wash tanks CW.

Such hot and cold solution washing sequences of the Sets/reactors can be carried out as follows:
pushing the electrolyte solution inside the Set/reactors Setj having a certain temperature level (i.e., hot or cold) by a washing solution having a same temperature level (i.e., hot or cold);
recycling the introduced washing solution having the same temperature level to wash the Set/reactors Setj;
pushing the washing solution having the same temperature level by a washing solution having the other temperature level (i.e., cold or hot);
recycling the introduced washing solution having the other temperature level to wash the Set/reactors Setj; and
pushing the washing solution having the other temperature level by an electrolyte solution having the other temperature level (i.e., cold or hot);

A hot/cold solution washing sequence is exemplified by phase Nos. 8 to 12 of Set9 of sub-system Sub2 (hereinafter Sub2/Set9) encircled by dashed-line box 25 in FIG. 10. In this specific and non-limiting example the washing phase Nos. 9 to 11 are carried used for replacing the hot electrolyte solution of the Oxygen production O phase contained inside Sub2/Set9 by a cold electrolyte solution of phase the Hydrogen production H phase. This exemplary procedure is carried out as follows:
in phase No. 8 (“LO-O”) the hot electrolyte solution of the Oxygen production O phase contained inside the Sub2/Set9 Set/reactors is pushed out (e.g., back into the Hot tank) by the hot washing solution from at least one of the hot wash tanks HW;
in phase No. 9 (“LO”) the hot washing solution is circulated inside Sub2/Set9 to perform a hot wash of the Set/reactors;
in phase No. 10 (“LH-LO”) the hot washing solution inside the Sub2/Set9 Set/reactors is pushed out (e.g., into at least one of the hot wash tanks HW) by a cold washing solution from at least one of the cold wash tanks CW;
in phase No. 11 (“LH”) the cold washing solution is circulated inside Sub2/Set9 to perform a cold wash of the Set/reactors; and.
in phase No. 12 (“H-LH”) the cold washing solution inside the Sub2/Set9 Set/reactors is pushed out (e.g., into at least one of the cold wash tanks CW) by a cold electrolyte solution from the Cold tank for starting a new Hydrogen production H phase.

Similarly, a cold/hot solution washing sequence is exemplified by phase Nos. 8 to 12 of Set6 of sub-system Sub1 (hereinafter Sub1/Set6) encircled by dashed-line box 26 in FIG. 10. In this specific and non-limiting example the washing phase Nos. 9 to 11 are carried used for replacing the cold electrolyte solution of the Hydrogen production H phase contained inside S2/S9 by a hot electrolyte solution of the Oxygen production H phase. This exemplary procedure is carried out as follows:
in phase No. 8 (“LH-H”) the cold electrolyte solution of the Hydrogen production H phase contained inside the Sub1/Set6 Set/reactors is pushed out (e.g., back into the Cold tank) by the cold washing solution from at least one of the cold wash tanks CW;
in phase No. 9 (“LH”) the cold washing solution is circulated inside Sub1/Set6 to perform a cold wash of the Set/reactors;
in phase No. 10 (“LO-LH”) the cold washing solution inside the Sub1/Set6 Set/reactors is pushed out (e.g., into at least one of the cold wash tanks CW) by a hot washing solution from at least one of the hot wash tanks HW;
in phase No. 11 (“LO”) the hot washing solution is circulated inside Sub1/Set6 to perform a hot wash of the Set/reactors; and.
in phase No. 12 (“O-LO”) the hot washing solution inside the Sub1/Set6 Set/reactors is pushed out (e.g., into at least one of the hot wash tanks HW) by a hot electrolyte solution from the Hot tank for starting a new Oxygen production O phase.

Accordingly, as exemplified in FIG. 10, in some embodiments the control system 16 (e.g., Wash module 16w) is configured such whenever a cold/hot solution washing sequence (e.g., 25 in FIG. 10) is carried out in one of the Sets/reactors Setj of a sub-system Subi, an opposite hot/cold solution washing sequence (e.g., 26 in FIG. 10) is carried out in one of the Sets/reactors Setj′ (j≠j is an integer) of a sub-system Subi′ (i′≠i is an integer), of the plant 15. It is noted that the return ductwork and valves used to push the solutions from the Sets/reactors Setj back to the Hot tank or the Cold tank, and/or the hot wash tanks HW or the cold wash tanks CW, are not shown in FIG. 10 for the sake of simplicity, but they can be easily determined and implemented by an average practitioner based on the disclosure of the present application.

With reference to FIGS. 3A to 3E, in some embodiments, in order to maintain a (full or quasi) steady-state, the following rules/assumption are followed:
Electrolyte pushes should be balanced (FIG. 3A): This means that whenever a certain Set i (where i≥1 is an integer number) is in the L-H push phase (shown in FIG. 2C), a different Set j (where i≠j≥1 is an integer number) should be performing a H-L push phase (shown in FIG. 2I). This way, the electrolyte level in the tanks (and reactors/Sets) is kept substantially constant.
Similarly, for the L-O and O-L phases, whenever a certain Set i is in the L-O push phase (shown in FIG. 2G), a different Set j (i≠j) should be in the O-L push phase (shown in FIG. 2E).
The same number of Sets needs to be in the H (i.e., active) phase (shown in FIG. 2A) at any given time (FIG. 3B), which means that the electric power supply should be (quasi or fully) constant.
The Sets are to be mostly in the H and O phases (shown in FIGS. 2A and 2F respectively), which means that the time duration in all of the other phases (T (H—), T (L-H), T (L), T (O-L), T (L-O) and T (H-L)) is to be minimized (as the system is not producing anything in these states), and the durations of the H and O phases (T (H) and T (O)) is to be maximized (FIG. 3C).

In addition, the following is assumed:
The time duration of the L phases (involving the Leftover tanks, shown in FIGS. 2D and 2H) is to be of at least two (2) steps i.e., at least two (2) L phase steps are performed in sequence whenever a L phase is carried out in a cycle (to ensure all the gas (hydrogen or oxygen) is washed out of the Sets/reactors). Accordingly, the total number of steps I_{T} of the L phases carried out in a cycle is to be I_{T}≥4 steps (FIG. 3D).
At least one H-phase (shown in FIGS. 2B and 2J) step is to be carried out before and after the H phase (of FIG. 2A). Accordingly, the number of H-phase steps h₍₋₎ in each cycle is h₍₋₎≥2 steps (FIG. 3E).

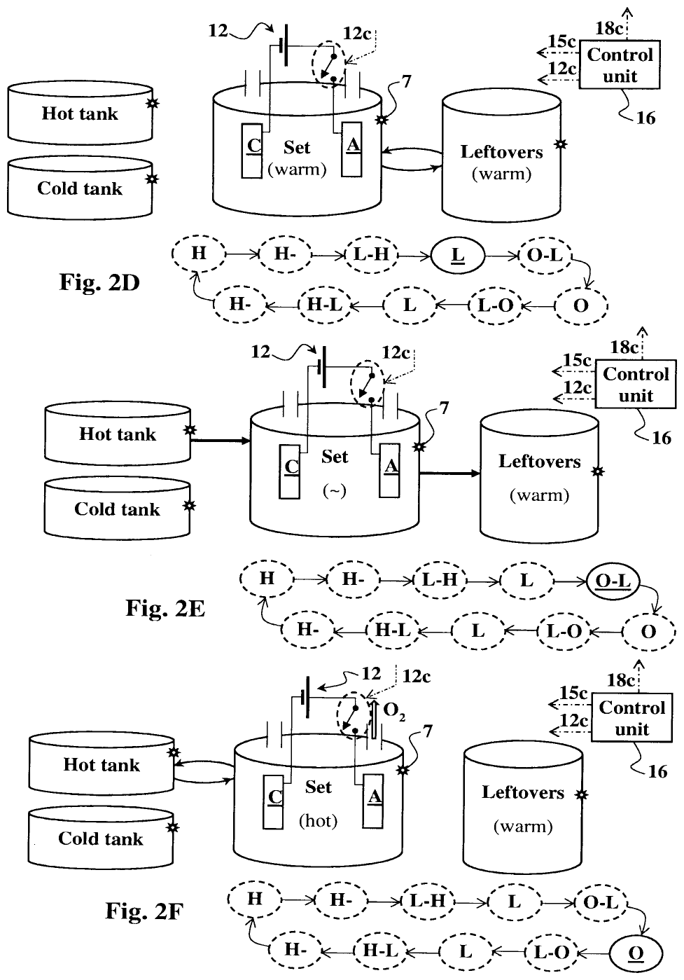

As a consequence, the conditions of FIGS. 4A to 4E are to be maintained during the system's operation:
The Sets should be kept in-phase one with respect to the other i.e., the Set i is kept p steps (where p>0 is an integer number) ahead of Set j (where i=j+1), which is p steps ahead of Set k (where k=i+1 is an integer number) etc. (FIG. 4A). Wherein the phase difference p between the Sets is to be maintained constant at all times (although it may be possible to build a sequence where the phase difference between the Sets is not fixed). This allows “syncing” the pushes for different Sets, for example, and to keep the number of Sets in the H phase constant.
If there are s Sets in the system and the phase difference between them is of p steps, the total number of steps (N) in each cycle is in some embodiments a multiplication of p by a positive integer number nₛ i.e., N=nₛ×p (FIG. 4B, where nₛ≥1). If this condition is not fulfilled, then after N steps the Sets of the system will not complete a full cycle.
The number h of H phase steps in a cycle is in some embodiments a multiplication of p by a positive integer number nₐ i.e., h=nₐ×p (FIG. 4C, where nₐ≥1). If this condition is not fulfilled, the number of Sets in the H phase cannot be kept constant at all times throughout the cycle. A Set that is in the H phase is referred to herein as an active set, and the system is configured in some embodiments to monitor the number of active Sets in each cycle and guarantee that it remain constant at all times.
The O-L and L-O phases (shown in FIGS. 2E and 2G respectively) are always carried out before and after the O phase. According to the above rules (FIGS. 3A to 3E), each O-L phase in Set i needs to be matched with a respective L-O phase in another Set, Set j (i≠j). In order to fulfil this requirement it is required that the “distance” between the O-L and L-O phases is to be a multiplication of the phase difference p by another positive integer number nₒ (where nₒ≥1). As the O phase is sandwiched between the O-L and L-O phases (i.e., the sequence obtained is: O-L, O, O, . . . , O, L-O). This means that the number of steps o in the O phase fulfils the following condition: o+1=nₒ×p, where nₒ≥1 is an integer number.
The L-H and H-L phases (shown in FIGS. 2C and 2I respectively) need to be synced as well. The H-L and L-H phases sandwich the sequence of phases L, O-L, O, L-O and L. Accordingly, the following sequence of phases is to be obtained: L-H, L, L, . . . , L, O-L, O, . . . , O, L-O, L, L, . . . , L, H-L. As there are nₒ×p−1 steps in the O phase, the distance between the L-H and H-L phases is in some embodiments nₒ×p−1+I_{T}+3 (when adding the O, L, O-L, and L-O phases). In order to sync the L-H and H-L phases this expression is to be a multiplicity of the phase difference p by a positive integer number n_{L} i.e., nₒ×p+I_{T}+2=n_{L}×p or I_{T}=p×(n_{L}−nₒ)−2.

The above rules, assumptions and conditions yields the following relationships:

$$N = {n}_{s} \times p$$

$$h = {n}_{a} \times p$$

$$o = {n}_{0} \times p - 1$$

$${I}_{T} = p \times ( {n}_{L} - {n}_{o} ) - 2$$

wherein Nis the total number of steps in an electrolysis cycle, p is the number of steps within the phase difference between two Sets i and j (i≠j), nₛ expresses the total number of steps N of each electrolysis cycle in terms of a number of phase difference (p) time durations, h is the total number of steps in the H phase, nₐ expresses the total number of steps in the H phase in terms of a number of phase difference (p) time durations, o is the total number of steps in the O phase, nₒ expresses the number of phase difference (p) time durations in the O phase plus one step, I_{T} is the total number of steps of all L phases in a cycle, and n_{L} expresses the time duration between the L-H and H-L phases as a number of phase differences (p) time durations.

Accordingly, the total number of steps N in an electrolysis cycle in possible embodiments is the sum of the total number of steps in: the H phase (i.e., h); the total number of steps of the L phases (i.e., IT); the total number of steps in the O phase (i.e., o); the total number of steps in the H-phase (i.e., h₍₋₎); and the total number of steps of the push phases L-H, O-L, L-O and H-L (the duration of each is a single step i.e., the push steps all together require 4 steps). Thus, the total number of steps N in an electrolysis cycle can be expressed as follows:

$$N = {I}_{T} + h + o + {h}_{( - )} + 4$$

$$N = [ p \times ( {n}_{L} - {n}_{o} ) - 2 ] + [ {n}_{a} \times p ] + [ {n}_{o} \times p - 1 ] + {h}_{( - )} + 4$$

$$N = p \times ( {n}_{L} + {n}_{a} ) + {h}_{( - )} + 1$$

wherein I_{T}≥4 and h₍₋₎≥2. From this result the total number of steps h₍₋₎ in the H-phase can be expressed as:

$${h}_{( - )} = N - p \times ( {n}_{L} + {n}_{a} ) - 1 = [ {n}_{s} \times p ] - p \times ( {n}_{L} + {n}_{a} ) - 1 = p \times ( {n}_{s} - {n}_{a} - {n}_{L} ) - 1$$

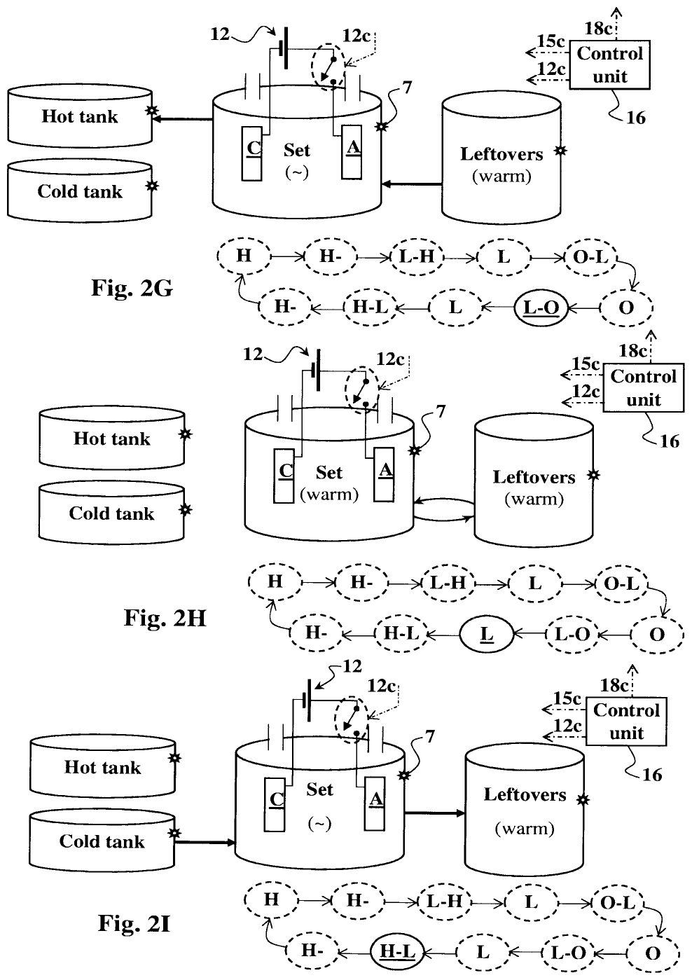

Since h₍₋₎≥2, I_{T}≥4 and o≥1, the following inequalities are obtained (FIG. 5A):

$${h}_{( - )} = p \times ( {n}_{s} - {n}_{a} - {n}_{L} ) - 1 \geq 2 : p \times ( {n}_{s} - {n}_{a} - {n}_{L} ) \geq 3 \qquad ( 1 )$$

$${I}_{T} = p \times ( {n}_{L} - {n}_{o} ) - 2 \geq 4 : p \times ( {n}_{L} - {n}_{o} ) \geq 6 \qquad ( 2 )$$

$$o = {n}_{o} \times p - 1 \geq 1 : p \times {n}_{o} \geq 2 \qquad ( 3 )$$

By combining inequalities (1) with (2), and (2) with (3), the following inequalities are respectively obtained (FIG. 5B):

$$p \times ( {n}_{s} - {n}_{a} - {n}_{o} ) \geq 9 \qquad ( 4 )$$

$$p \times {n}_{L} \geq 8 \qquad ( 5 )$$

Accordingly, under all the constraints, it is desired to minimize the expression (nₛ−nₐ−nₒ) (FIG. 5C). Alternatively, a number of “waste” H and/or L phase steps may be carried out beyond the minimum required, but this would not result in optimal Set operation.

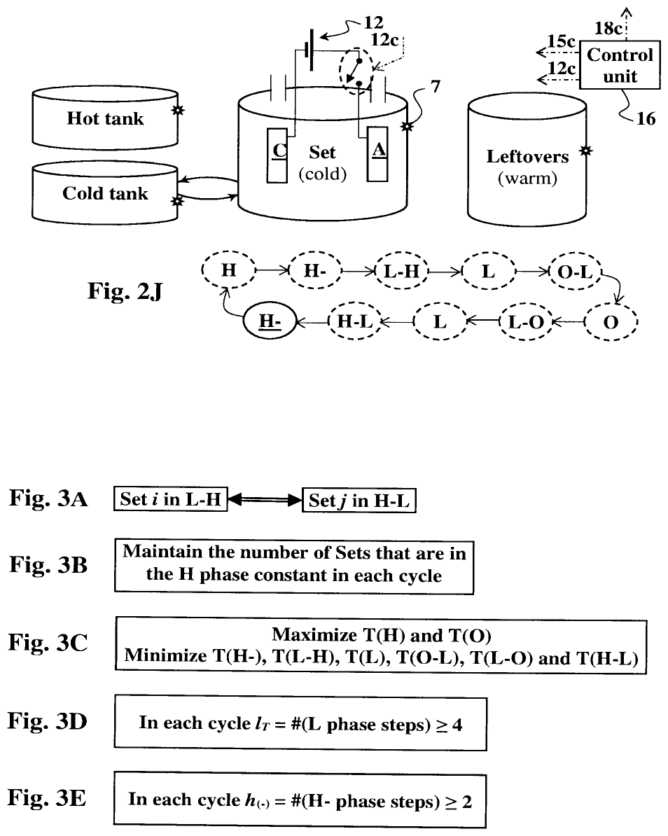

In some embodiments the above inequalities are used by the control system 16 to guarantee efficient and substantially constant electrolysis production by a plurality of Sets (Set 1, Set 2, . . . , Set i) of the plant 15. Further analysis of these inequalities can be used to derive further possible control rules/conditions, as described hereinbelow. As summarized in FIG. 6A, from inequality (2) it follows that for:

$$p = 1 : ( {n}_{L} - {n}_{o} ) \geq 6 steps$$

$$p = 2 : ( {n}_{L} - {n}_{o} ) \geq 3 steps$$

since 3≤p≤5 provides that 1≤(6/p)≤2 (as only integer numbers are relevant), for:

$$3 \leq p \leq 5 : ( {n}_{L} - {n}_{o} ) \geq 2 steps$$

and since p≥6 provides that 0≤(6/p)≤1, for:

$$p \geq 6 : ( {n}_{L} - {n}_{o} ) \geq 1 steps .$$

FIG. 6B summarizes the above control rules.

As summarized in FIG. 6B, based on the above rules and I_{T}=p×(n_{L}−nₒ)−2, the values of I_{T} can be minimized, as follows, for:

$$p = 1 : min ( {I}_{T} ) = 4 steps$$

$$p = 2 : min ( {I}_{T} ) = 4 steps$$

$$3 \leq p \leq 5 : min ( {I}_{T} ) = 2 \times p - 2 steps$$

$$p \geq 6 : min ( {I}_{T} ) = p - 2 steps$$

As summarized in FIG. 6C, from inequality (1) and (nₛ−nₐ−n_{L})≥3/p it follows that for:

$$p = 1 : ( {n}_{s} - {n}_{a} - {n}_{L} ) \geq 3$$

$$p = 2 : ( {n}_{s} - {n}_{a} - {n}_{L} ) \geq 2$$

$$p = 3 : ( {n}_{s} - {n}_{a} - {n}_{L} ) \geq 1$$

and as summarized in FIG. 6D, it follows from h₍₋₎=p×(nₛ−nₐ−N_{L})−1≥2 that minimal values of h₍₋₎ are such that for:

$$p = 1 : {h}_{( - )} = 2 steps$$

$$p = 2 : {h}_{( - )} = 3$$

$$p \geq 3 : {h}_{( - )} = p - 1 steps$$

As summarized in FIG. 6E, from inequality (3) and o=nₒ×p−1≥1, it follows that for:

$$p = 1 : {n}_{o} = 2 steps$$

$$p \geq 2 : {n}_{o} = 1 steps$$

As summarized in FIG. 6F, from inequality (4), and nₛ≥9/p+nₐ+nₒ, it follows that since for:

$$p = 1 , {n}_{o} = 2 and {n}_{a} \geq 1 : {n}_{s} \geq 9 + {n}_{a} + {n}_{o} \to {n}_{s} = 12 steps$$

$$p = 2 , {n}_{o} , {n}_{a} \geq 1 : {n}_{s} \geq 5 + {n}_{a} + {n}_{o} \to {n}_{s} = 7 steps$$

$$p = 3 , {n}_{o} , {n}_{a} \geq 1 : {n}_{s} \geq 3 + {n}_{a} + {n}_{o} \to {n}_{s} = 5 steps$$

$$p = 4 , {n}_{o} , {n}_{a} \geq 1 : {n}_{s} \geq 3 + {n}_{a} + {n}_{o} \to {n}_{s} = 5 steps$$

$$5 \leq p \leq 8 , 1 < p / 9 < 2 : {n}_{s} \geq 2 + {n}_{a} + {n}_{o} \to {n}_{s} = 4 steps$$

$$p \geq 9 , 0 < p / 9 < 1 : {n}_{s} \geq 1 + {n}_{a} + {n}_{o} \to {n}_{s} = 3 steps$$

As summarized in FIG. 6G, inequality (4) further provides that for:

$$p = 1 : {n}_{s} - {n}_{a} - {n}_{o} \geq 9 steps$$

$$p = 2 : {n}_{s} - {n}_{a} - {n}_{o} \geq 5 steps$$

$$p = 3 , 4 : {n}_{s} - {n}_{a} - {n}_{o} \geq 3 steps$$

$$p = 5 - 8 : {n}_{s} - {n}_{a} - {n}_{o} \geq 3 steps$$

$$p \geq 9 : {n}_{s} - {n}_{a} - {n}_{o} \geq 1 steps$$

As summarised in FIG. 6H, the above results for p, nₛ, nₐ, and nₒ and the minimizations of I_{T}≥4 and h₍₋₎≥2, can be combined to derive the number of steps in each of the different phases, where for the H, N, and O, phases the number of steps is given by:

$$N = {n}_{s} \times p$$

$$h = {n}_{a} \times p$$

$$o = {n}_{o} \times p - 1$$

In order to support solar power and continue to be efficient, in some embodiments the plant 16 initially starts to operate (e.g., at the beginning of the day) with a reduced/minimum number of Sets, and increases the number of Sets up to a define maximal capacity e.g., at midday, and towards the ending of its operation (e.g., at the end of the day) the number of Sets is decreased back to the reduced/minimum number of Sets, before shutting down the plant 16 at the most efficient way to start its operation back the day after.

In order to add an active Set during operation, the plant/system should be at a state similar to that exemplified in FIG. 7A, wherein one of the Sets is in the L-O phase (Set 4 in this example), and which occurs every 6-7 steps, depending on the plant/system configuration. From this stage of the plant/system operation a new Set can be started e.g., new Set 5 added in FIG. 7B. Accordingly, if there are n simultaneously operating Sets; Set 1, Set 2, . . . , Set n, in order to start operation on a new Set n+1, a sequence of at least n−1 phases of the Set to be added are to be found in one of the currently operating Sets with a similar position such that the n-Sets can continue normally their operation.

In order to deactivate a Set the plant/system needs to be at a state similar to that exemplified in FIG. 8A, wherein one of the Sets in L-O phase (Set 5 in this example), such a state occurs every 6-7 states, depending on the plant/system configuration. The deactivated Set (in this example Set 5) should have 2 more steps, L and H-L, before it is deactivated, as shown in FIG. 8B. Thereafter, the operation of the plant/system can continue normally with the reduced number of Sets, As exemplified in FIG. 8C. Thus, in some embodiments, a Set is deactivated after carrying out a washing phase after one of the production phases (i.e., H or O). In possible embodiments the time durations of the electrolysis process phases are dynamically set before, and/or during plant operation, as explained hereinbelow. The below description utilizes the following definitions:
τ_{c}: an electrolysis cycle (e.g., as shown in FIGS. 2A to 2J) time duration;
Nₛ: number of sets Setj in a sub-system Subi,
Nₐ: number of active sets in a sub-system Subi,
Σₕ: length/time duration of the Hydrogen production H phase;
τₗₒ: length/time duration of the L-O and O-L phase pushes;
τₗₕ: length/time duration of the L-H and H-L phase pushes;
τₒ: length/time duration of the Oxygen production O phase;
τₗ: average length/time duration of the leftover/wash L phase; and
τₕ₋: average length/time duration of the H-phase.

A “phase” between two Sets ϕ can be thus defined as −

$$ϕ = \frac{{τ}_{c}}{{N}_{s}} ,$$

wherefrom the following expression is obtained:

$${τ}_{c} = ϕ {N}_{s} \qquad ( 6 )$$

For the same reasons, as in the fixed-length steps analysis, the length/time duration of the Hydrogen production H phase can be expressed as

$${τ}_{h} = \frac{{N}_{a}}{{N}_{s}} {τ}_{c} ,$$

wherefrom the following expression is obtained:

$${τ}_{h} = ϕ {N}_{a} \qquad ( 7 )$$

Similarly, the time duration between the L-O and L-H pushes (between which the Oxygen production O phase is performed) can be required to be equal to a multiplicity of ϕ by a positive integer number Nₒ, which yields the expression:

$${τ}_{o} + {τ}_{lo} = ϕ {N}_{o} \qquad ( 8 )$$

Similarly, the time duration between the L-H and H-L pushes is also required to be a multiplicity of ϕ by a positive integer number k, which yields the expression:

$${τ}_{lh} + {τ}_{o} + 2 {τ}_{lo} + {τ}_{{l}_{1}} + {τ}_{{l}_{2}} = ϕ k \qquad ( 9 )$$

where τₗ_{ᵢ} for i∈1,2 are the lengths/time durations of the leftover/wash steps, which in principle do not have of the same time duration. However, 2τₗ=τₗ_{₁}+τₗ_{₂} can be defined to obtain the expression:

$${τ}_{lh} + {τ}_{o} + 2 {τ}_{lo} + 2 {τ}_{l} = ϕ k , \qquad ( 10 )$$

and by substituting expression (8) in expression (10), he following relationship is obtained:

$${τ}_{lh} + ϕ {N}_{o} + {τ}_{lo} + 2 {τ}_{l} = ϕ k ,$$

which provides the relationship:

$${τ}_{lh} + {τ}_{l o} + 2 {τ}_{l} = ϕ ( k - {N}_{o} ) . \qquad ( 11 )$$

Since it is desired to minimize the time durations of the push (L-H, L-O etc) phases and the leftover/wash (L) phases, and since their time durations are non-zero, the left side of equation (11) is minimized when k−Nₒ=1, which thus provides that:

$${τ}_{l h} + {τ}_{l o} + 2 {τ}_{l} = ϕ \qquad ( 12 )$$

Summing-up the entire electrolysis cycle/sequence is summed-up yields the expression:

$$2 {τ}_{h -} + 2 {τ}_{l h} + 2 {τ}_{l} + 2 {τ}_{l o} + {τ}_{h} + {τ}_{o} = {τ}_{c} \qquad ( 13 )$$

(as explained above with respect to τₗ, the two H— phases before and after the Hydrogen production H phase, can be of different time durations, and τₕ₋ is defined as the average of the average time durations of these H— phases).

Substituting expressions (6), (7) and (8) into (13), yields:

$$2 {τ}_{h -} + 2 {τ}_{lh} + 2 {τ}_{l} + {τ}_{lo} = ϕ ( {N}_{s} - {N}_{a} - {N}_{o} ) , \qquad ( 14 )$$

and substituting expression (12) yields:

$$2 {τ}_{h -} + {τ}_{l h} = ϕ ( {N}_{s} - {N}_{a} - {N}_{o} - 1 ) . \qquad ( 15 )$$

Since τₓ>0 for x∈{h−, lh, l, lo}, and since ϕ>0, it follows that:

$${N}_{s} - {N}_{a} - {N}_{o} - 1 \geq 1 , \qquad ( 16 )$$

$$and thus :$$

$${N}_{s} \geq {N}_{a} + {N}_{o} + 2. \qquad ( 17 )$$

From expression (14) the following is obtained:

$$2 {τ}_{h -} + 2 {τ}_{l h} + 2 {τ}_{l} + {τ}_{lo} \geq 2 ϕ \qquad ( 18 )$$

The following system of independent (in) equalities is thus obtained:

$${τ}_{c} = ϕ {N}_{s} \qquad ( 6 )$$

$${τ}_{h} = ϕ {N}_{a} \qquad ( 7 )$$

$${τ}_{o} + {τ}_{lo} = ϕ {N}_{o} \qquad ( 8 )$$

$${τ}_{l h} + {τ}_{l o} + 2 {τ}_{l} = ϕ \qquad ( 12 )$$

$${N}_{s} \geq {N}_{a} + {N}_{o} + 2 \qquad ( 17 )$$

$$2 {τ}_{h -} + 2 {τ}_{l h} + 2 {τ}_{l} + {τ}_{lo} \geq 2 ϕ , \qquad ( 18 )$$

wherein there are 6 (six) equations and 11 (eleven) unknowns (τ_{c}, τₕ, τₒ, τₗ, τₕ₋, τₗₕ, τₗₒ, ϕ, Nₛ, Nₐ, Nₒ). If ϕ, Nₛ, Nₐ, τₗₒ and τₗₕ are fixed (in other possible embodiments other/different set of unknowns could have been chosen to be fixed), provides that:

$${τ}_{c} = ϕ {N}_{s} \qquad ( 19 a )$$

$${τ}_{h} = ϕ {N}_{a} \qquad ( 19 b )$$

$${τ}_{o} = ϕ {N}_{o} - {τ}_{lo} \qquad ( 19 c )$$

$$2 {τ}_{l} = {τ}_{lh} + {τ}_{lo} - ϕ \qquad ( 19 d )$$

$${N}_{o} \leq {N}_{s} - {N}_{a} - 2 \qquad ( 19 e )$$

$$2 {τ}_{h -} + 2 {τ}_{l} \geq 2 ϕ - 2 {τ}_{lh} - {τ}_{lo} \qquad ( 19 f )$$

$$We also have :$$

$${τ}_{l} , {τ}_{h -} , {τ}_{o} > 0 \qquad ( 14 g )$$

Solving this system will result in a valid sequence. However, an optimal sequence will reduce the time the system is not in the Hydrogen or Oxygen production. If expression (19e) is multiplied by ϕ the following expression is obtained:

$$ϕ {N}_{o} \leq ϕ {N}_{s} - ϕ {N}_{a} - 2 ϕ , \qquad ( 20 )$$

That is (by substituting expressions (6), (7), (8)):

$${τ}_{c} - {τ}_{h} - {τ}_{0} \geq 2 ϕ - {τ}_{lo} . \qquad ( 21 )$$

Since it is desired to minimize the left-hand side of expression (21), which is achieved when the inequality ‘≥’ is replaced by a quality ‘=’ namely:

$${τ}_{c} - {τ}_{h} - {τ}_{0} = 2 ϕ - {τ}_{lo} , \qquad ( 21 a )$$

which means that expression (19) becomes:

$${N}_{o} = {N}_{s} - {N}_{a} - ϕ \qquad ( 22 )$$

Similarly, from expression (18):

$$2 {τ}_{h -} + 2 {τ}_{lh} + 2 {τ}_{l} + {τ}_{lo} \geq 2 ϕ , \qquad ( 18 )$$

In order to minimize the left-hand side, which means the the inequality ≥ is replace by a quality sign ‘=’:

$$2 {τ}_{h -} + 2 {τ}_{lh} + 2 {τ}_{l} + {τ}_{lo} = 2 ϕ , \qquad ( 23 )$$

which provides the following system of equations to be solved:

$${τ}_{c} = ϕ {N}_{s} \qquad ( 24 a )$$

$${τ}_{h} = ϕ {N}_{a} \qquad ( 24 b )$$

$${τ}_{o} = ϕ {N}_{o} - {τ}_{lo} \qquad ( 24 c )$$

$$2 {τ}_{l} = {τ}_{lh} + {τ}_{lo} - ϕ \qquad ( 24 d )$$

$${N}_{o} = {N}_{s} - {N}_{a} - 2 \qquad ( 24 e )$$

$$2 {τ}_{h -} + 2 {τ}_{l} = 2 ϕ - 2 {τ}_{lh} - {τ}_{lo} , \qquad ( 24 f )$$

$$which yields :$$

$${τ}_{c} = ϕ {N}_{s} \qquad ( 25 a )$$

$${τ}_{h} = ϕ {N}_{a} \qquad ( 25 b )$$

$${τ}_{o} = ϕ {N}_{o} - {τ}_{lo} \qquad ( 25 c )$$

$$2 {τ}_{l} = ( {τ}_{lh} + {τ}_{lo} - ϕ ) \qquad ( 25 d )$$

$${N}_{o} = {N}_{s} - {N}_{a} - 2 \qquad ( 25 e )$$

$$2 {τ}_{h -} = 3 ϕ - 3 {τ}_{lh} - {τ}_{lo} - 2 \qquad ( 25 f )$$

As discussed hereinabove, τₗ and τₕ₋ are each an average of two phases. However, as these phases perform the same “operation”, there's little point in making them different.

Optionally, but in some embodiments preferably, various parameters of the electrolysis process and its of phases thereof are determined as follows:

Given τₕ (length/duration of the Hydrogen production phase H) τₗₒ and τₗₕ (length/duration of pushes) and (integral) Nₛ≥3 (number of Sets in the system), the number of active Sets (integral) is chosen under the following conditions:

$$\frac{{τ}_{h}}{{τ}_{lh} + {τ}_{lo}} < {N}_{a} \leq {N}_{s} - 3 \qquad {N}_{a} < {τ}_{h} / {τ}_{lh}$$

$$and$$

$$ϕ = {τ}_{h} / {N}_{a} \qquad ( 19 b )$$

the length of the cycle can be expressed as follow:

$${τ}_{c} = ϕ {N}_{s} \qquad ( 19 c )$$

The Oxygen production phase length No (integer) can be chosen such that:

$$1 \leq {N}_{o} \leq {N}_{s} - {N}_{a} - 2 \qquad ( 19 e )$$

(above, Nₐ was chosen such that at least Nₒ=1 solves this inequality)

In addition in order to satisfy the following expression:

$${N}_{o} > \frac{{τ}_{lo}}{{τ}_{h}} {N}_{a}$$

the length of the Oxygen production phase is:

$${τ}_{o} = ϕ {N}_{o} - {τ}_{lo} \qquad ( 19 c )$$

(because of the way Nₒ was chosen, we have τₒ>0)

The sum of the two left over/washing phases (which in principle could be different) is thus:

$$2 {τ}_{l} = {τ}_{lh} + {τ}_{lo} - ϕ \qquad ( 19 d )$$

(τₗ is guaranteed to be >0, because of the way Nₐ was chosen) Where τₗ is the average length of the two leftover/washing phases (in a sequence, there are two leftover “phases”. 2τₗ is the sum of both. We never care about the length of one of them—just the sum). Lastly, we need to fix the H— phase (again, there are two such phases in a sequence), thus:

$$2 {τ}_{h -} \geq 2 ϕ - 2 {τ}_{lh} - {τ}_{lo} - 2 {τ}_{l} \qquad ( 19 f )$$

(τₕ₋ is guaranteed to be positive because of the way we chose Nₐ. Specifically:

$$2 ϕ - 2 {τ}_{lh} - {τ}_{lo} - 2 {τ}_{l} = 2 ϕ - 2 {τ}_{lh} - {τ}_{lo} - ( {τ}_{lh} + {τ}_{lo} - ϕ ) = 3 ϕ - 3 {τ}_{lh} = 3 ( {τ}_{h} / {N}_{a} - {τ}_{lh} ) > 0 {τ}_{h} / {N}_{a} - {τ}_{lh} > {τ}_{h} / ( {τ}_{h} / {τ}_{lh} ) - {τ}_{lh} = {τ}_{lh} - {τ}_{lh} = 0$$

It should be understood that throughout this disclosure, where a process or method is shown or described, the steps/acts of the method may be performed in any order and/or simultaneously, and/or with other steps/acts not-illustrated/described herein, unless it is clear from the context that one step depends on another being performed first. In possible embodiments not all of the illustrated/described steps/acts are required to carry out the method.

As described hereinabove and shown in the associated figures, the present application provides control schemes for electrolysis systems/processes and related methods. While particular embodiments of the disclosed subject matter have been described, it will be understood, however, that the disclosed subject matter is not limited thereto, since modifications may be made by those skilled in the art, particularly in light of the foregoing teachings. As will be appreciated by the skilled person, the disclosed subject matter can be carried out in a great variety of ways, employing more than one technique from those described above, all without exceeding the scope of the claims.

1-66. (canceled)

67. An electrolysis system comprising:
a plurality of reactors, each comprising electrolysis electrodes and configured to carry out a sequence of phases of an electrolysis process phase-shifted with respect to a sequence of phases of the electrolysis process carried out by at least another one of said plurality of reactors;
one or more power sources for driving the electrolysis processes carried out by said plurality of reactors; and
a control system configured to monitor changes in a power capacity of at least one of said one or more power sources and based thereon perform at least one of the following:
(i) activate or deactivate one or more of the electrolysis processes carried out by said plurality of reactors;
(ii) adjust a time duration of at least one of the phases of said electrolysis process;
(iii) adjust the power supplied to at least one of said plurality of reactors from said one or more power sources; and/or
(iv) adjust, remove or introduce, at least one phase of said electrolysis process.

68. The system of claim 67 configured to carry out the electrolysis process in each reactor in continuously repeated cycles, each cycle comprising at least one Hydrogen production (H) phase from a cold electrolyte solution, followed by a cold electrolyte pushout phase (L-H) of replacing said cold electrolyte by a washing solution, followed by at least one washing phase (L) of washing the electrolysis electrodes of said reactor, followed by a washing solution pushout phase (O-L) of replacing said washing solution by a hot electrolyte solution, followed by at least one Oxygen production (O) phase from said hot electrolyte, followed by a hot electrolyte pushout phase (L-O) of replacing said hot electrolyte solution by a washing solution, followed by at least one washing phase (L) of washing the electrolysis electrodes of said reactor, followed by a washing solution pushout phase (H-L) of replacing said washing solution by a cold electrolyte solution, followed by at least one Hydrogen production arresting phase (H—).

69. The system of claim 68, comprising at least one Hydrogen production arresting phase (H—) between the at least one Hydrogen production (H) phase from a cold electrolyte solution and the cold electrolyte pushout phase (L-H), and/or after the washing solution pushout phase (H-L) and before a new Hydrogen production (H) phase of a new cycle is commenced.

70. The system of claim 68 configured to determine the time durations of one or more of the phases and/or of the entire electrolysis process based on at least one of the following: an electrolysis cycle time duration τ_{c}; and/or number of reactors in the system Nₛ; and/or number of active reactors in the system Nₐ; and/or length/time duration of the Hydrogen production (H) phase τₕ; and/or length/time duration of the (L-O) and (O-L) pushes τₗₒ; and/or length/time duration of the (L-H) and (H-L) pushes τₗₕ; and/or length/time duration of the Oxygen production (O) phase τₒ; and/or average length/time duration of the leftover/wash (L) phase τₗ; and/or average length/time duration of the (H—) phase τₕ₋; and/or configured to determine the time durations of one or more of the phases and/or of the entire electrolysis process based on the following: length/time duration of the (L-H) and (H-L) pushes τₗₕ; length/time duration of the (L-O) and (O-L) pushes τₗₒ; length/time duration of the Hydrogen production (H) phase τₕ; number of reactors in the system Nₛ; and/or number of active reactors in the system Nₐ; and/or configured to determine the time durations of one or more of the phases and/or of the entire electrolysis process based on the following: length/time duration of the Hydrogen production (H) phase τₕ; length/time duration of the Oxygen production (O) phase τₒ; average length/time duration of the leftover/wash (L) phase τₗ; length/time duration of the (L-H) and (H-L) pushes τₗₕ.

71. The system of claim 68, wherein time duration of each of the Hydrogen production (H) phase, of the Hydrogen production arresting phase (H—), of the washing phase (L), and of the Oxygen production (O) phase, substantially equals to a multiplication of a step time duration by a natural number, said step time duration being a time duration of at least one of the pushout phases.

72. The system of claim 71 configured such that the total time duration of the washing phases (L) in each cycle substantially equals to at least: a multiplication of the step time duration by four when the number of phase shifts between the reactors is one, two or three; a multiplication of the step time duration by six when the number of phase shifts between the reactors is four; and/or a multiplication of the step time duration by ten when the number of phase shifts between the reactors is five; and/or the time duration of the total phase shift minus a time duration of two phases when the number of phase shifts between the reactors is greater than five; and/or configured such that the total time duration of the Hydrogen production arresting phase (H—) in each cycle substantially equals to at least: a multiplication of the step time duration by two when the number of phase shifts between the reactors is one; and/or a multiplication of the step time duration by five when the number of phase shifts between the reactors is two; and/or a multiplication of the step time duration by two when the number of phase shifts between the reactors is three; and/or a multiplication of the step time duration by three when the number of phase shifts between the reactors is four; and/or a multiplication of the step time duration by four when the number of phase shifts between the reactors is of five phases; and/or the time duration of the total phase shift between the reactors minus a time duration of one phase when the number of phase shifts between the reactors is greater than five; and/or configured such that the total time duration of the cycle substantially equals to at least: a multiplication of the step time duration by twelve and by the number of phase shifts between the reactors when the number of phase shifts between the reactors is one; and/or a multiplication of the step time duration by seven and by the number of phase shifts between the reactors when the number of phase shifts between the reactors is two; and/or a multiplication of the step time duration by five and by the number of phase shifts between the reactors when the number of phase shifts between the reactors is three; and/or a multiplication of the step time duration by four and by the number of phase shifts between the reactors when the number of phase shifts between the reactors is inclusively between four to eight; and/or a multiplication of the step time duration by three and by the number of phase shifts between the reactors when the number of phase shifts between the reactors is greater than eight; and/or configured such that the total time duration of the Oxygen production (O) phase(s) in each cycle is greater than: a multiplication of the step time duration by two and by the number of phase shifts between the reactors minus a time duration of one phase when the number of phase shifts between the reactors is one; and/or a multiplication of the step time duration by the number of phase shifts between the reactors minus a time duration of one phase when the number of phase shifts between the reactors is greater than one; and/or configured such that subtraction of a total number of the step time duration in the cold electrolyte pushout phase (L-H) from a division of a difference between the total number of the step time duration in the cycle and the total number of the step time duration in the Hydrogen production (H) phase by the number of phase shifts between the reactors substantially equals to at least: nine when the number of phase shifts between the reactors is one; and/or five when the number of phase shifts between the reactors is two; and/or three when the number of phase shifts between the reactors is three or four; and/or two when the number of phase shifts between the reactors is inclusively between five and eight; and/or one when the number of phase shifts between the reactors is greater than eight.

73. The system of claim 67, wherein at least one, or all, of the power sources are renewable power sources.

74. The system of claim 73, wherein the control system is configured to receive and process sensory data/signals indicative of changes in environmental conditions, and predict based thereon a likelihood of changes in the power capacity of the renewable power sources.

75. The system of claim 68, comprising a reservoir containing the hot electrolyte solution, a reservoir containing the cold electrolyte solution, a reservoir containing the washing solution, and equipment for controllably streaming said solutions between said reservoirs and each one of the plurality of reactors, and wherein the control system is configured to stream solution to each one of the plurality of reactors from said reservoirs at each phase of the electrolysis process carried out therein.

76. The system of claim 75, wherein the control system is configured to apply electric voltage over the electrolysis electrodes of each one of the plurality of reactors only when carrying out a Hydrogen production (H) phase of the electrolysis process, and to circulate the cold electrolyte solution between the cold electrolyte solution reservoir and said reactors carrying out the Hydrogen production (H) phase of the electrolysis process; and/or the control system is configured to push the cold electrolyte solution back into the cold electrolyte solution reservoir in the cold electrolyte pushout phase (L-H), by streaming the washing solution from the washing solution reservoir thereinto; and/or the control system is configures to circulate the cold electrolyte solution between the cold electrolyte solution reservoir and the reactors in the Hydrogen production arresting phase (H—), without applying the electric voltage to their electrolysis electrodes; and/or the control system is configured to circulate the washing solution between the washing solution reservoir and the reactors in the washing phase (L) for washing gaseous products residues from the electrolysis electrodes of said reactors; and/or the control system is configured to push the washing solution from the reactors back into the washing solution reservoir in the washing solution pushout phase (O-L), by streaming the hot electrolyte solution from the hot electrolyte solution reservoir into said reactors; and/or the control system is configured to circulate the hot electrolyte solution between the hot electrolyte solution reservoir and each one of the plurality of reactors in the Oxygen production phase (O) of the electrolysis process; and/or wherein the control system is configured to push the hot electrolyte solution back into the hot electrolyte solution reservoir in the hot electrolyte pushout phase (L-O), by streaming the washing solution from the washing solution reservoir thereinto; and/or the control system is configured to push the washing solution from the reactors back into the washing solution reservoir in the washing solution pushout phase (H-L), by streaming the cold electrolyte solution from the cold electrolyte solution reservoir into said reactors.

77. The system of claim 76 configured to maintain the washing solution in the washing solution reservoir at a temperature substantially smaller than a temperature of the hot electrolyte solution and substantially greater than a temperature of the cold electrolyte solution.

78. The system of claim 76, wherein the washing solution reservoir comprises one or more cold washing solution sub-reservoirs for cold washing solutions maintained at temperature(s) greater than a temperature of the cold electrolyte solution, and one or more hot washing solution sub-reservoirs for hot washing solutions maintained at temperature(s) smaller than a temperature of the hot electrolyte solution and greater than temperature(s) of said cold washing solutions, and wherein the control system is configured to use the cold washing solutions from said one or more cold washing solution sub-reservoirs in the hot electrolyte pushout phase (L-O) and in the at least one washing phase (L) carried out thereafter, and to use the hot washing solutions from the one or more hot washing solution sub-reservoirs in the cold electrolyte pushout phase (L-H) and in the at least one washing phase (L) carried out thereafter.

79. An electrolysis plant comprising two or more of the electrolysis systems of claim 67 utilizing a single hot electrolyte reservoir, a single cold electrolyte reservoir, and one or more washing solutions reservoir, and wherein the control system is configured to carry out a sequence of the (L-H), (L) and (O-L), phases in one of said two or more electrolysis systems while carry out a sequence of the (L-O), (L) and (H-L), phases in at least another one of said two or more electrolysis systems.

80. An electrolysis method comprising carrying out an electrolysis process having sequence of phases in a plurality of reactors, each of said reactors comprising electrolysis electrodes and carrying out said electrolysis process with phase-shift with respect to at least another one of said plurality of reactors, monitoring changes in power capacity of one or more power sources used for carrying out said electrolysis process by said plurality of reactors and based thereon performing at least one of the following: activating or deactivating one or more of the electrolysis processes carried out by said plurality of reactors; adjusting a time duration of at least one of the phases of said electrolysis process; adjusting power supplied to at least one of said plurality of reactors from said one or more power sources; and/or adjusting, removing or introducing, at least one phase of said electrolysis process.

81. The method of claim 80, comprising carrying out the electrolysis process in the reactors in a continuously repeated cycles, each cycle comprising at least one Hydrogen production (H) phase from a cold electrolyte solution, followed by a cold electrolyte pushout phase (L-H) of replacing said cold electrolyte by a washing solution, followed by at least one washing phase (L) of washing the electrolysis electrodes of said reactor, followed by a washing solution pushout phase (O-L) of replacing said washing solution by a hot electrolyte solution, followed by at least one Oxygen production (O) phase from said hot electrolyte, followed by a hot electrolyte pushout phase (L-O) of replacing said hot electrolyte solution by a washing solution, followed by at least one washing phase (L) of washing the electrolysis electrodes of said reactor, followed by a washing solution pushout phase (H-L) of replacing said washing solution by a cold electrolyte solution.

82. The method of claim 81, comprising at least one Hydrogen production arresting phase (H—) between the at least one Hydrogen production (H) phase from a cold electrolyte solution and the cold electrolyte pushout phase (L-H), and/or after the washing solution pushout phase (H-L) and before a new Hydrogen production (H) phase of a new cycle is commenced.

83. The method of claim 81, comprising setting a time duration of each of the Hydrogen production (H) phase, of the Hydrogen production arresting phase (H—), of the washing phase (L), and of the Oxygen production (O) phase, to substantially equal to a multiplication of a step time duration by a natural number, said step time duration being a time duration of at least one of the pushout phases.

84. The method of claim 81, comprising adjusting electric current supplied to at least one of the plurality of reactors when it is determined that a reduction in the power capacity of the power sources is likely to cause short-term fluctuations in the power supply.

85. The method of claim 84, comprising further adjusting a time duration of at least one of the phases of the electrolysis process when it is determined that reduction in the power capacity of the power sources is likely to cause longer-term fluctuations in the power supply.

86. The method of claim 85, comprising further adjusting a time duration of at least one of the phases and/or a sequence of phases of the electrolysis process when it is determined that reduction in the power capacity of the power sources is likely to substantially reduce efficiency of the electrolysis process.
